(19) United States
(12) Patent Application Publication
(10) Pub. No.: US 2006/0085861 A1
(43) Pub. Date: Apr. 20, 2006

(54) Tracing slaves from reflectors with deterministic packet marking

(76) Inventors: Andrey Belenky, Brooklyn, NY (US); Nirwan Ansari, Montville, NJ (US)

Correspondence Address: KLAUBER & JACKSON, 411 HACKENSACK AVENUE, HACKENSACK, NJ, 07601, US

(21) Appl. No.: 11/079,452

(22) Filed: Mar. 14, 2005

Related U.S. Application Data
(60) Provisional application No. 60/552,645, filed on Mar. 12, 2004.
(60) Provisional application No. 60/552,647, filed on Mar. 12, 2004.
(60) Provisional application No. 60/553,212, filed on Mar. 15, 2004.

(51) Int. Cl. H04N 7/16

(52) U.S. Cl. 726/26

(57) ABSTRACT

The method is based on marking packets with the partial address information of ingress interface only. The attack victim is able to recover the complete address(es) information after receiving several packets from a particular attacking host or hosts. The full path is not really essential for the traceback since it can be different for different packets for different reasons. In order to make tracing slaves from reflectors possible, the potential reflectors keep the log of two fields of every packet, which they receive. The two fields are source address for the mark. The entry is kept in the log for a reasonable period of time in order for the victim to be able to use that information. By analyzing the marks from the logs, which cannot be spoofed, and that are sure to be from the slaves, the victim can reconstruct the ingress addresses of the slaves which sent the packets to the reflectors.

### RELATED APPLICATIONS

This application claims priority from U.S. Provisional patent Application Ser. No. 60/552,645, filed Mar. 12, 2004; Ser. No. 60/552,647 filed Mar. 12, 2004, and 60/553,212 filed Mar. 15, 2004.

### FIELD OF INVENTION

This invention relates generally to methodology useful in securing the Internet infrastructure, and more specifically relates to methods for tracing internet attacks back to their source or sources.

### BACKGROUND OF INVENTION

In recent years, much interest and consideration has been paid to the topic of securing the Internet infrastructure that continues to become a medium for a broad range of transactions. A number of approaches to security have been proposed, each attempting to mitigate a specific set of concerns. The specific threat, which is the main focus of this application, is anonymous attacks. In anonymous attacks, the identity of the attacker(s) is not immediately available to the victim since the Source Address (SA) field in the attack packets is spoofed. (Distributed) Denial of Service ((D)DoS) attacks are anonymous attacks, which currently attract much attention since there is no obvious way to prevent them or to trace them.

Currently there are several ways of dealing with anonymous attacks. They include source address filtering, SYN Flood Protection, and implementing a BlackHole Router server. Source address filtering, introduced in P. Ferguson and D. Senie, Network Ingress Filtering: defeating denial of service attacks which employ IP source address spoofing, RFC 2827, May, 2000, prevents packets with values of the SA field outside the preset appropriate range from entering the Internet. If deployed on every ingress interface, this would drastically reduce the number of anonymous packets in the Internet. Unfortunately, source address filtering incurs high overhead and administrative burden and is ineffective, unless carried out almost everywhere. SYN Flood Protection monitors half-open TCP connections and does not allow more than a certain number of them to exist simultaneously. SYN Flood protection prevents only SYN Flood type (D)DoS attacks and is useless against other types of anonymous attacks. Finally, the ISPs can determine the interface, where the DoS attack packets entered its network, by “Black Holing” a router on its network, if the customer reports the attack. This method involves human interaction, works only for the backscatter attacks, as discussed in D. Moore, G. M. Voelker and S. Savage, Inferring Internet Denial of Service Activity, Proc. of 10th {USENIX} Security Symposium, 2001, pp. 9-22, must be performed while the attack is still in progress, and is limited to the boundaries of the given ISP.

The currently available methods for dealing with anonymous attacks are not comprehensive. They either deal with a very limited set of the problems or are too expensive to implement and enforce. While it may be simply impossible to prevent attackers from attempting an attack, it might be possible to lessen, or even completely eliminate the effects of the attack by not allowing the packets to reach the victim(s). This is the proactive approach discussed in detail in R. K. C. Chang, Defending against Flooding-Based Distributed Denial-of-Service Attacks: A Tutorial, EEE Commun. Mag, Vol. 40, No. 10, pp. 42-51, October 2002. The reality, however, is that prevention of all attacks on the Internet is far from reality. When prevention fails, a mechanism to identify the source(s) of the attack is needed to at least insure accountability for these attacks. This is the motivation for designing IP Traceback schemes.

After several high-profile DDoS attacks on major U.S. web sites in 2000, numerous IP traceback approaches have been suggested to identify the attacker(s). See A. Belenky and N. Ansari, On IP traceback, IEEE Commun. Mag, vol 41, no, 7, pp. 142-153, July 2003. IP Traceback is defined in Chang (op. cit.) as identifying a source of any packet on the Internet. The previously proposed schemes can be categorized in four broad groups. One group of the solutions relies on the routers in the network to send their identities to the destinations of certain packets, either encoding this information directly in rarely used bits of the IP header, or by generating a new packet to the same destination. The biggest limitation of solutions of this type is that they are focused only on flood-based DoS and DDoS attacks, and cannot handle attacks comprised of a small number of packets. Moreover, for large scale DDoS attacks, these schemes are not very effective.

The second group involves logging some fields of every packet, or the digest of every packet on all the routers that a packet traverses. During the traceback, all of the routers are polled and the path of a given packet is reconstructed by correlating the routers, which have stored the information about this packet. The solutions of this group are not easily scalable, have relatively high ISP involvement, and have no post-mortem traceback capabilities. The third group involves the centralized management of the traceback process and changing the routing in the network with tunneling to be able to identify the packets' origin. The shortcomings of these schemes are high ISP involvement and high bandwidth and processing overhead associated with tunneling. The final group is referred to as the state of network inference schemes. Controlled flooding, described in H. Burch and B. Cheswick, Tracing Anonymous Packets to Their Approximate Source, Proc. of 2000 USENIX LISA Conference, December 2000, pp. 319-327, is the only scheme in this group. The scheme only works for DoS attacks. The attack path is determined while the attack is still in progress by systematically loading different links on the network and observing the effect on the victim. If loading of a particular link results in decrease in the rate of the attack traffic, then this link is on the attack path. Controlled flooding is limited to tracing DoS attacks only, and it is manual. It also utilizes a questionable approach of inducing DoS attacks for the purposes of traceback.

### SUMMARY OF INVENTION

Now in accordance with the present invention a method for IP Traceback is disclosed which is based on Deterministic Packet Marking (DPM). Aspects of DPM are also disclosed and claimed in our concurrently filed U.S. patent applications Serial Nos. ______ and ______, the entire disclosures of which are hereby incorporated by reference. The DPM approach is scalable, simple to implement, and introduces no bandwidth and practically no processing overhead on the network equipment. It is capable of tracing thousands of simultaneous attackers during a DDoS attack. Given sufficient deployment on the Internet, DPM is capable of tracing back to the slaves responsible for DDoS attacks that involve reflectors. Tracing back to the slaves cannot be done by other existing schemes. Most of the processing is done at the victim. The traceback process can be performed post-mortem allowing for tracing the attacks that may not have been noticed initially, or the attacks which would deny service to the victim so that traceback is impossible in real time. The involvement of the Internet Service Providers (ISPs) is very limited, and changes to the infrastructure and operation required to deploy DPM are minimal. DPM performs the traceback without revealing the internal topology of the provider's network, which is a desirable quality of a traceback scheme.

In order to make tracing slaves from reflectors possible, the potential reflectors keep the log of two fields of every packet, which they receive. The two fields are source address and the mark. The entry is kept in the log for a reasonable period of time in order for the victim to be able to use that information. By analyzing the marks from the logs, which cannot be spoofed, and that are sure to be from the slaves, the victim can reconstruct the ingress addresses of the slaves, which sent the packets to the reflectors.

### DESCRIPTION OF DRAWINGS

The invention is diagrammatically illustrated, by way of example, in the drawings appended hereto, in which:

FIG. 1 depicts the method for basic deterministic packet marking (DPM);

FIG. 2 illustrates the Pseudo code for the basic DPM;

FIG. 3 depicts mark encoding for single digest DDoS modification;

FIG. 4 illustrates RecTbl with k=8, d=10, a=4; mark recording; and address recovery;

FIG. 5 shows encoding for multiple digest DDoS modification;

FIG. 6 illustrates address recovery for the multiple digest DDoS modification;

FIG. 7 shows the pseudo code for the modified multiple digest DPM algorithm;

FIG. 8 is a diagram depicting IP fragmentation;

FIG. 9 shows the pseudo code for the fragment-persistent DPM;

FIG. 10 shows the pseudo code for the fragment-persistent DPM with fragment counters;

FIG. 11 shows the pseudo code for the practical compromise fragment-persistent DPM.

FIG. 12 illustrates compositions of (D)DoS attacks;

FIG. 13 depicts DPM traceback data structures;

FIG. 14 is an illustration of reflector log requests and responses;

FIG. 15 illustrates the victim's processing of log responses; and

FIG. 16 shows pseudo code for the traceback procedure.

### DESCRIPTION OF PREFERRED EMBODIMENTS

The basic DPM is a packet marking algorithm. We first consider the general principle behind DPM and discusses the most basic implementation of the scheme.

By “Deterministic Packet Marking” we refer to the fact that every packet traversing a DPM-enabled router is marked, i.e., the packet is inscribed with partial information of the router interface, as opposed to “Probabilistic Packet Marking” in which each packet is marked by a router along the traversed path with a probability, say, 0.04 (4%), i.e., some packets may not be marked at all.

The two key assumptions applicable to the method are (1) that an attacker may generate any packet; and (2) that routers are both CPU and memory limited.

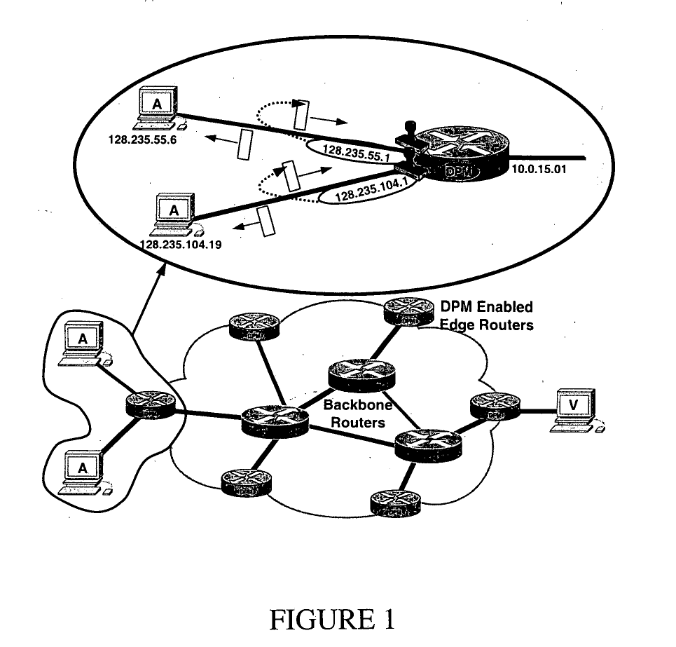

The 16-bit packet Identification (ID) field and 1-bit Reserved Flag (RF) in the IP header are used to mark packets. Each packet is marked when it enters the network. This mark remains unchanged for as long as the packet traverses the network. This automatically removes the issue of mark spoofing which other marking schemes have to account for. The packet is marked by the interface closest to the source of the packet on an edge ingress router, as shown in FIG. 1. The routers with the engraved “DPM” signify the routers with DPM enabled, and the rubber-stamps signify the interfaces on these routers that actually perform the marking. The mark contains the partial address information of this interface, and will be addressed later herein. The interface makes a distinction between incoming and outgoing packets. Incoming packets are marked; outgoing packets are not marked. This ensures that the egress router will not overwrite the mark in a packet placed by an ingress router.

For illustrative purposes, assume that the Internet is a network with a single administration. In this case, only interfaces closest to the customers on the edge routers will participate in packet marking. Every incoming packet will be marked. Should an attacker attempt to spoof the mark in order to deceive the victim, this spoofed mark will be overwritten with a correct mark by the very first router the packet traverses. A continuous perimeter of DPM enabled interfaces should be maintained. The deployment should start with the largest, tier-1, ISPs and expand in concentric circles until the ingress interfaces are enabled. When an interface becomes enabled, other interfaces, which are closer to the tier-1 ISPs and are traversed by the marked packets should be disabled.

Procedure

A 32-bit IP address needs to be passed to the victim. A total of 17 bits are available to pass this information: 16-bit ID field and 1-bit RF. Clearly, a single packet would not be enough to carry the whole IP address in the available 17 bits. Therefore, it will take at least two packets to transport the whole IP address. An IP address is split into two segments, 16 bits each: segment 0—bits 0 through 15, and segment 1—bits 16 through 31. The marks are prepared in advance in order to decrease the per packet processing. Each mark has two fields: Segment Number and Address bits. With equal probability, the 17-bit field comprised of the ID field and RF of each incoming packet will be populated with either of those two marks.

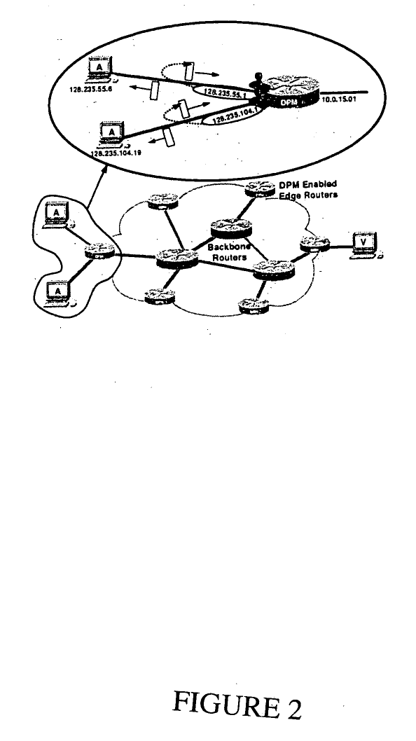

At the victim, a table matching the source addresses to the ingress addresses is maintained. When a marked packet arrives at the victim, the victim will first determine if the given packet is an attack packet. If it is, the victim would check to see if the table entry for a source address of this packet already exists, and create it if it does not. Then, it writes address bits of the segment into the corresponding bits of the ingress IP address value. After both segments corresponding to the same ingress address have arrived at the destination, the ingress address for a given source address becomes available to the victim. The details of the procedure are shown in FIG. 2.

Multiple Attackers and IP Source Address Inconsistency

The limitation of the basic DPM in handling a certain type of DDoS attacks lies in the fact that the destination would associate segments of the ingress address with the source address of the attacker. If it could be guaranteed that only one host participating in the attack has a given source address, even though it might have been spoofed, and that the attacker would not change its address during the attack, the basic DPM would be sufficient. There are two situations when the reconstruction procedure of the basic DPM is inadequate. First, is the situation where two hosts with the same SA attack the victim. The ingress addresses corresponding to these two attackers are A₀ and A₁, respectively. The victim would receive four address segments: A₀ [0], A₀ [1], A₁ [0], and A₁ [1]. The victim, not being equipped to handle such attack, would eventually reconstruct four ingress addresses since four permutations are ultimately possible: A₀ [0]. A₀ [1], A₀ [0] .A₁ [1], A₁ [0]. A₀ [1], and A₁ [0] .A₁ [1], where ‘.’ denotes concatenation. Only two of the four would be valid.

A typical metric of evaluation of the traceback schemes for DDoS attacks is the rate of false positives or false positive rate. In the context of DPM, a false positive is defined as an incorrectly identified ingress address. The rate of false positives refers to the ratio of the incorrectly identified ingress addresses to the total number of identified ingress addresses. In the above example, the false positive rate for that particular attack is 50%. Clearly, the false positive rate would increase even further if the number of attackers, with the same SA, was larger.

Second, consider a (D)DoS attack, where the attackers change their source addresses for every packet they send. The basic DPM will be unable to reconstruct any valid ingress addresses since none of the entries in the IngressTbl would have a complete ingress address.

General Principle of Handling DDoS Attacks

A general principle in handling (D)DoS attacks of these types is to rely only on the information transferred in the DPM mark. The DPM mark can be used to not only transfer the bits of the ingress address but also some other information. This additional information should enable the destination to determine which ingress address segments belong to which ingress address.

The reconstruction procedure utilizes the data structure called Reconstruction Table (RecTbl). The destination first puts the address segments in RecTbl, and then only after correctly identifying the ingress address out of the many possible address segments permutations, transfers it to IngressTbl

Single Digest Modification to DPM

The scheme described here utilizes a hash function, H(x). To simplify the performance analysis, the hash function is assumed to be ideal. It is also assumed that the hash function is known to everybody, including all DPM-enabled interfaces, all destinations which intend to utilize DPM marks for traceback, and the attackers. The constraint of 17 bits still remains, and so a longer digest would result in fewer bits of the actual address transmitted in each mark, and consequently, the higher number of packets required for traceback.

Mark Encoding

In the basic DPM, the ingress address was divided into two segments. In this modified scheme, the ingress address is divided into k segments. Also, more bits are required to identify the segment. Instead of a single bit required for two segments in the basic DPM, log₂(k) are required for this scheme. The remaining bits are be used for the digest. Independently of which segment of the address is being sent to the victim, the digest portion of the mark will always remain the same for a given DPM interface. This enables the victim to associate the segments of the ingress address with each other to reconstruct the whole address.

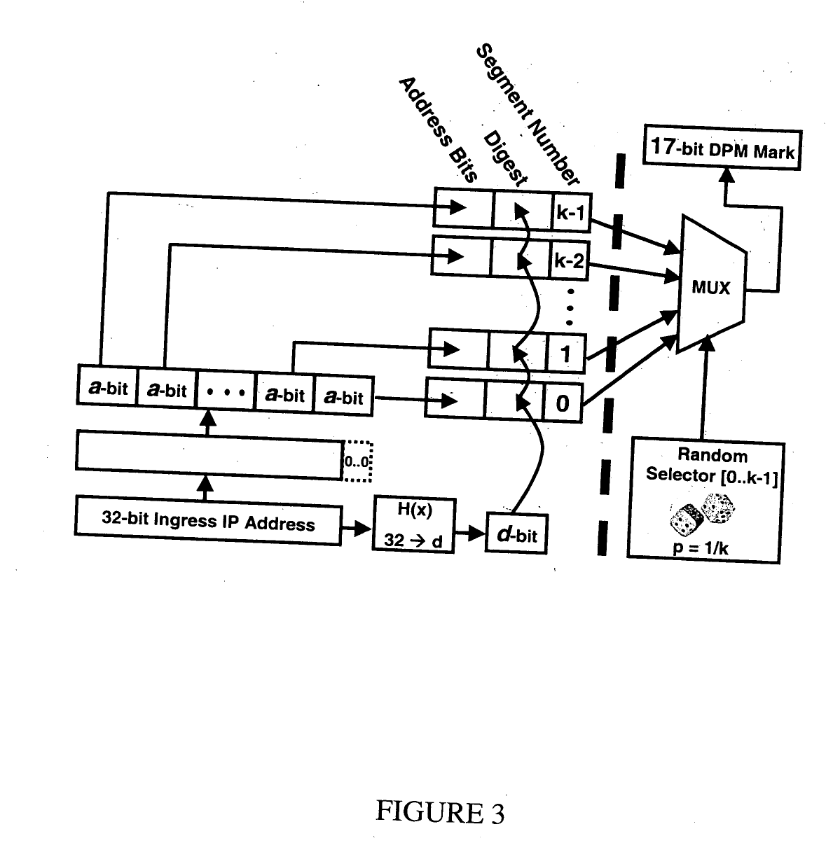

FIG. 3 shows the schematics of the approach. The DPM mark consists of three fields: a-bit address segment field, d-bit digest field, and s-bit segment number field. Some padding may be required so that the address is split into segments of equal length.

At startup the DPM-enabled interface prepares k marks for all segments of the address. A d-bit hash value, or digest, of the ingress address is calculated once and then inserted in the digest field of every mark. Each of the k marks has address bits set to a different segment of the ingress address. The segment number field is set to the appropriate value. These operations are shown to the left of the bold dotted line in FIG. 3. The processing required for every packet will be limited to generating a small random number from 0 to k−1 and inserting a corresponding mark into the packet header.

Reconstruction by the Victim

The reconstruction procedure of this scheme consists of two separate processes: Mark Recording and Ingress Address Recovery. The reason for separating these two tasks is that the attack packets may arrive at the destination faster than they can be analyzed. The mark recording process sets the appropriate bits in RecTbl to indicate which marks have arrived at the destination. Address recovery checks those bits, composes address segment permutations, and determines which ones are valid ingress addresses.

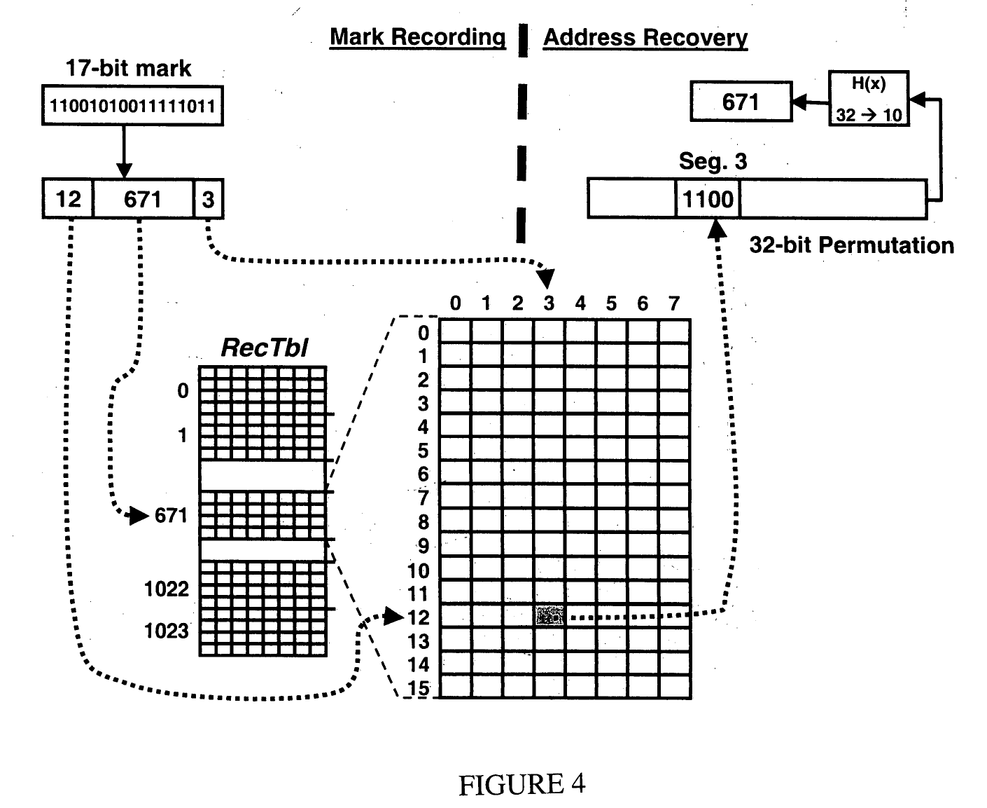

RecTbl is a 2¹⁷ bit structure, where every possible mark can be uniquely represented. It consists of 2^{d} areas. Each area consists of k segments, and each segment consists of 2^{a} bits. FIG. 4 shows an example of RecTbl, where k, d, and a are 8, 10 and 4, respectively. When a mark becomes available to the mark recording process, it sets the appropriate bit in the RecTbl. For a given attacker, the ingress address can possibly be hashed into 2^{d} digest values. The digest is extracted from the mark and the area where the bit will be set is determined. The segment number field in the mark indicates the segment in the RecTbl area, where the appropriate bit would be set. Finally, the value of the address bits in the mark indicates the actual bit, which will be set to ‘1’. This process is repeated for every mark.

The address recovery process is a part of a larger traceback procedure. It analyzes each area of the RecTbl. Once again, it runs independently from the mark recording process, thus allowing post-mortem traceback. The value of a certain bit in RecTbl indicates that the corresponding mark has arrived at the victim. For example, bit 12 in segment 3 of area 671 set to ‘1’ means that there is an ingress address of interest, with digest of 671 having segment 3 equal to ‘1100’ ₂ as shown in FIG. 4. This segment has to be combined with other segments of this area in order to create permutations of segments. Hash function, H(x), is applied to each of these permutations. If the result matches the area number, which is actually the digest embedded in the marks (in this example 671), then the recovery process concludes that this permutation of segments is in fact a valid ingress address.

Analysis

Regarding the number of attackers, N, that this modified scheme can traceback with the false positive rate limited to 1%, we first consider the origin of false positives. If there is only one ingress address with a given digest, there will be no false positives; however, as N increases, the chance of the digest repeated for another address also increases. The expected number of digests for a certain number of N can be thought of as the expected number of the faces turning up on a 2^{d}-sided die after N throws. This is a special case of a classical occupancy problem. See W. Feller, An Introduction to Probability Theory and Its Applications, John Wiley & Sons, Inc., 1968. The expected number of different digests, E[H], is:

$$E [ H ] = {2}^{d} - {2}^{d} {( 1 - \frac{1}{{2}^{d}} )}^{N} . \qquad ( 1 )$$

Therefore, the rate of false positives is 0 for the values of N, for which the expected number of digests, E[H], equals to N, since every ingress address will have a unique digest.

Since there may be more than one address resulting in the same digest, each segment associated with a given digest would have a certain number of values. For example, if two addresses have the same digest, segment 0 in the area of the RecTbl corresponding to this digest could have either one or two bits set to ‘1’. If segment 0 in these two addresses is the same, then there would be only one bit set to ‘1’, and if segment 0 of one address is different from segment 0 of the second address, then two bits will be set to ‘1’. The expected number of values that a segment will assume can also be thought of as the expected number of the faces turning up on a 2^{a}-sided die after N_{d} throws [Feller, op. cit.], where N_{d} is the number of ingress addresses with the same digest. The expected number of different values the segment will take is

$${2}^{a} - {2}^{a} {( 1 - \frac{1}{{2}^{a}} )}^{{N}_{d}} , \qquad ( 2 )$$

for those areas, which have segments of more than one ingress addresses, and 1 for those which have segments of only a single ingress address. The expected number of all permutations of address segments for a given digest is

$${[ {2}^{a} - {2}^{a} {( 1 - \frac{1}{{2}^{a}} )}^{{N}_{d}} ]}^{k} .$$

Recall that after a permutation of segments is obtained, the hash function H(x) is applied to it, and if the result does not match the original digest, that permutation is not considered. The expected number of permutations that result in a given digest for a given area of the RecTbl is

$$\frac{{[ {2}^{a} - {2}^{a} {( 1 - \frac{1}{{2}^{a}} )}^{{N}_{d}} ]}^{k}}{{2}^{d}} .$$

The number of false positives for a given area would be the total number of permutations, less the number of valid ingress addresses, which match the digest. For this modification, just a few areas, which have segments of more than one ingress addresses, will produce more than 0.01N of false positives. We assume that for all those areas N_{d}=2. The number of those areas is N−E[H], and the number of valid ingress addresses with segments in those areas is 2(N−E[H]). The number of false positives is given by

$$\frac{{( N - E [ H ] ) [ {2}^{a} - {2}^{a} {( 1 - \frac{1}{{2}^{a}} )}^{2} ]}^{k} - 2 ( N - E [ H ] )}{{2}^{d}} \qquad ( 3 )$$

This number has to be less than 1% of N Therefore, Eq. (3) has to be set to be less or equal to 0.01N, and solved for N Recall that a, d, and E[H] can be expressed in terms of k. The maximum N, N_{MAX}, which would satisfy this inequality, is difficult to be expressed in terms of k. However, it is possible to find N_{MAX} by substitution. Table tab:single provides the values of N_{MAX} for selected k. Another important consideration is the expected number of datagrams required for reconstruction. This number is related to k, the number of segments that the ingress address was split. The larger the k, the more different packets it would be required for the victim to receive in order to reconstruct the ingress address. The expected number of datagrams, E[D], required to be marked by a single DPM-enabled interface in order for the victim to be able to reconstruct its ingress address is given by the Coupon Collector problem [Feller op. cit.]:

$$E [ D ] = k ( \frac{1}{k} + \frac{1}{k - 1} + … + 1 ) .$$

Table I provides the value of E[D] for selected values of k.

TABLE I

| k | a | s | d | N_{MAX} | E[D] |
|---|---|---|---|---|---|
| 2 | 16 | 1 | 0 | 1 | 3 |
| 4 | 8 | 2 | 7 | 26 | 9 |
| 8 | 4 | 3 | 10 | 108 | 22 |
| 16 | 2 | 4 | 11 | 45 | 55 |
| 32 | 1 | 5 | 11 | 45 | 130 |

Multiple Digest DDoS Modification to DPM

In the scheme described above, a single hash function, H(x), was used for identifying segments of an ingress address. While this allows for identifying several ingress addresses of simultaneous attackers, this number is not sufficient for the real attacks. A modification, requiring a family of hash functions, is now considered.

Mark Encoding

In this scheme, the family of t hash functions, H₀(x) through H_{f-1}(x), is used to produce f digests of the ingress address. As in the single digest scheme, the address segment and the segment number are transferred in each mark. Instead of the single digest, however, one of the several digests produced by each of f hash functions concatenated with the function identifier is embedded in the mark. The d-bit field, which was used solely for the digest in the single-digest scheme, is split into two fields: log₂(f)-bit long field carrying the identifier of the hash function, and d-bit field with the digest itself.

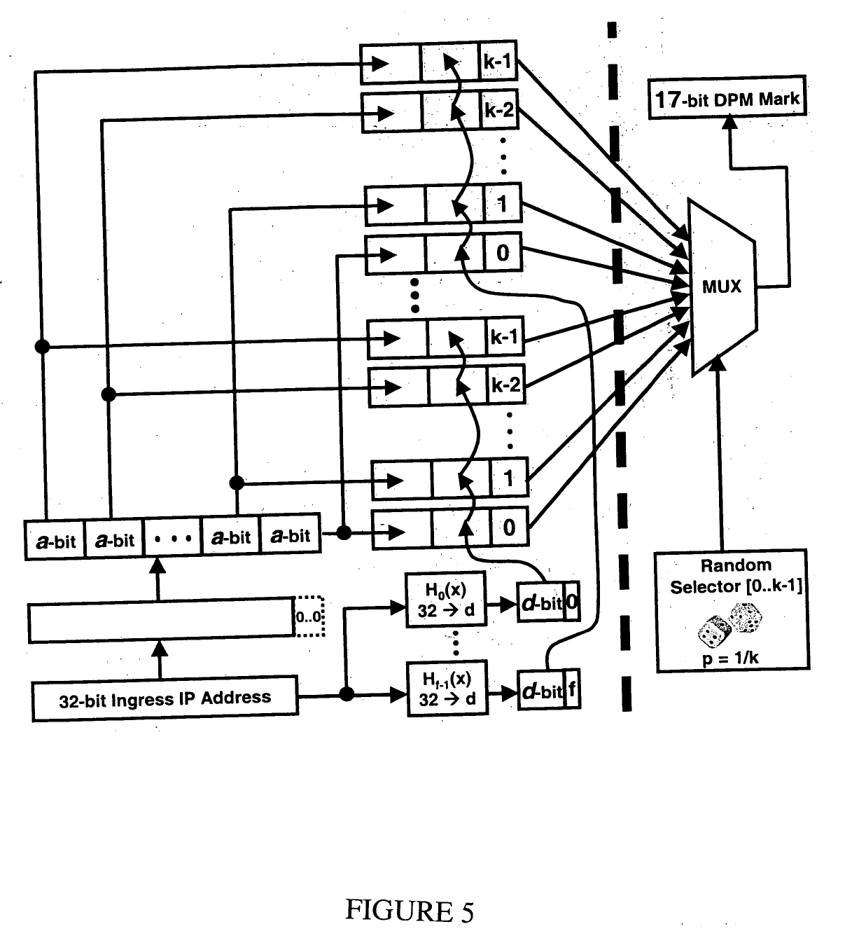

FIG. 5 illustrates the process of the mark encoding. The process is very similar to the one described in the single digest modification, but differs in that for every ingress address, not k, but f×k marks have to be created at startup and then randomly selected for every packet. This does not affect the DPM-enabled interface per-packet overhead since per-packet will be limited to generating a small random number and overwriting 17 bits in the header, just as for the single-digest or basic DPM schemes.

Reconstruction by the Destination

Reconstruction by the destination is also similar to that described in the single digest modification. The structure of RecTbl has to be changed slightly. The RecTbl will consist of f smaller parts. Every one of those parts will have the structure identical to the RecTbl described in Section sec:MultSingleReconstruction (2^{d} areas, k segments in every area, and 2^{a} bits in every segment). The mark recording process first examines the hash function identifier field. Then it proceeds to the corresponding part of the RecTbl. Having identified the part in the RecTbl, the area, and the segment, the appropriate bit is set to ‘1’, as in the single-digest scheme.

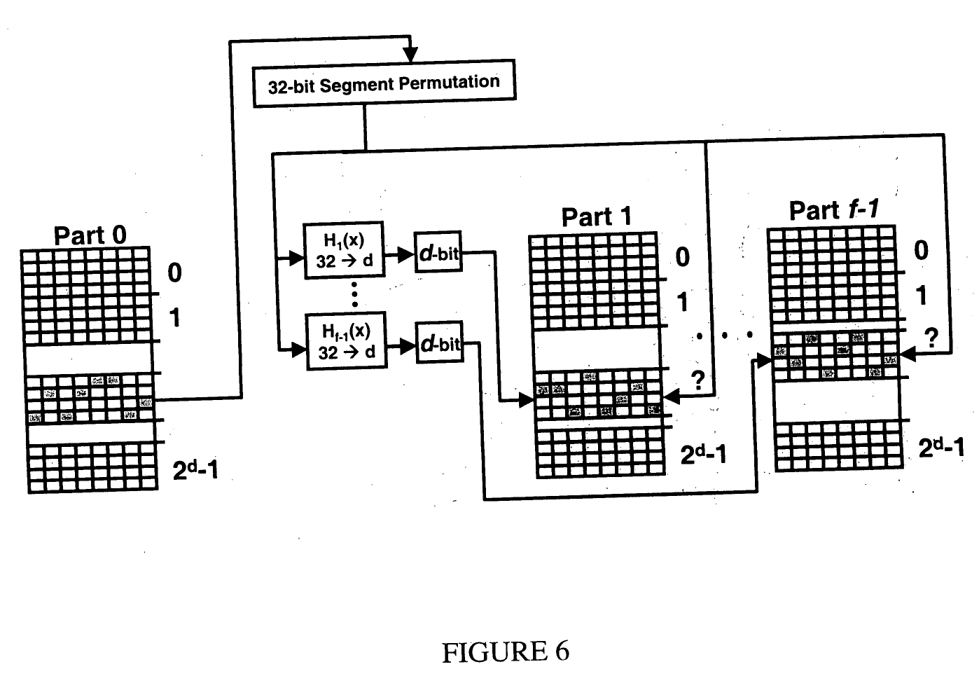

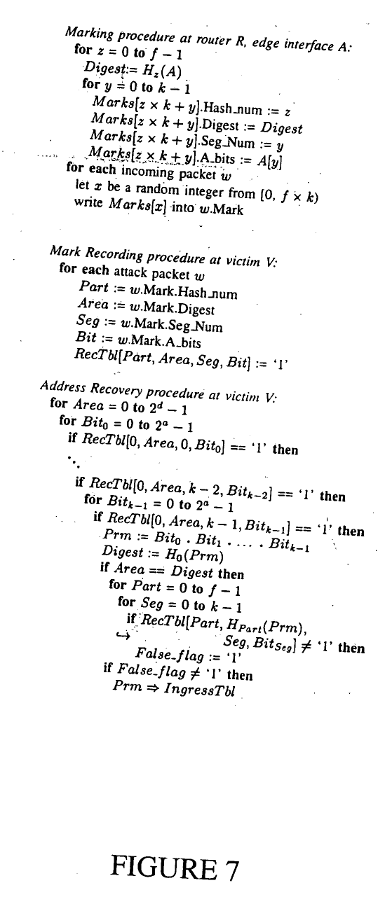

The address recovery process, shown in FIG. 6, identifies the permutations which match the digest in areas of Part0 of RecTbl. Once a permutation is validated by comparing its digest obtained by applying H₀(x) to the area number, the rest of the hash functions; H₁(x) to H_{f-1}(x), are applied to it to produce f−1 digests. These digests are used to verify the existence of this permutation in other parts of RecTbl. The process then checks these areas of the remaining parts for the permutation in question. If the permutation is present in the appropriate area of every part of the RecTbl, it is concluded that the permutation is a valid ingress address. Notice that the permutation does not have to be verified in every part. It is known that the digest obtained by applying Hᵢ(x) to the permutation being checked will match the area number since the area was identified by this operation. Therefore, such verification would be redundant and will always produce a positive outcome. The pseudo code in FIG. 7 provides the details of the mark encoding, mark recording, and address recovery processes.

Analysis

Again here we consider for this scheme that the purpose remains the same: to find N_{MAX}, the maximum number of simultaneous attackers, which can be traced back with the false positive rate not exceeding 1%. For the multiple digest scheme, the number of false positives in one area of RecTbl can be higher than in a single digest scheme because the same false positive has to appear in the appropriate areas of all other parts of RecTbl in order to be identified as an ingress address.

Recall, from the single digest case, that the expected number of permutations in a given digest is given by

$${[ {2}^{a} - {2}^{a} {( 1 - \frac{1}{{2}^{a}} )}^{{N}_{d}} ]}^{k} ,$$

where N_{d} is the number of ingress addresses with this digest. Since for the multiple digest scheme, unlike the single digest scheme, the number of ingress addresses with the same digest will be more than 2, the following analysis is more suitable. The number of ingress addresses with the same digest is

$$\frac{N}{E [ H ]} .$$

The number of permutations in a single digest is then

$${[ {2}^{a} - {2}^{a} {( 1 - \frac{1}{{2}^{a}} )}^{\frac{N}{E [ H ]}} ]}^{k} .$$

The number of false positives for this digest is

$$\frac{{[ {2}^{a} - {2}^{a} {( 1 - \frac{1}{{2}^{a}} )}^{\frac{N}{E [ H ]}} ]}^{k} - N}{{2}^{d}} .$$

The number of false positives in Part0 is given by:

$$\frac{E [ H ]}{{2}^{d}} ( {[ {2}^{a} - {2}^{a} {( 1 - \frac{1}{{2}^{a}} )}^{\frac{N}{E [ H ]}} ]}^{k} - N ) .$$

For large values of N, E[H]=2^{d}, and thus

$$\frac{E [ H ]}{{2}^{d}} = 1.$$

So the number of false positives in Part0 is

$${[ {2}^{a} - {2}^{a} {( 1 - \frac{1}{{2}^{a}} )}^{\frac{N}{E [ H ]}} ]}^{k} - N . \qquad ( 4 )$$

Once the permutation was identified as a possible ingress address in Part0, the remaining digests are calculated. Since we assume uniform distribution of addresses, any permutation is as likely to appear as any other. The probability of any random permutation to appear is

$$\frac{1}{{2}^{32}} .$$

The probability that a given permutation, which is a false positive, will occur in the appropriate area of Part1 is:

$$\frac{{[ {2}^{a} - {2}^{a} {( 1 - \frac{1}{{2}^{a}} )}^{\frac{N}{E [ H ]}} ]}^{k}}{{2}^{32}}$$

This expression is not divided by 2^{d} because if the permutation in question is present in the identified areas of all other parts, it must match the appropriate digest per discussion at the end of Section sec:MultMultipleReconstruciton. The probability that a given permutation will occur in the appropriate areas of all parts of RecTbl is:

$${[ \frac{{[ {2}^{a} - {2}^{a} {( 1 - \frac{1}{{2}^{a}} )}^{\frac{N}{E [ H ]}} ]}^{k}}{{2}^{32}} ]}^{f - 1}$$

Multiplying this expression by the number of false positives in Part0 results in the number of false positives, after areas matching the digests 1 through f−1 in all the other parts of the RecTbl were checked. This is the total number of false positives for the RecTbl. Setting it not to exceed

$$\frac{N}{100}$$

results in the following inequality:

$$\frac{{\{ {[ {2}^{a} - {2}^{a} {( 1 - \frac{1}{{2}^{a}} )}^{\frac{N}{E [ H ]}} ]}^{k} \}}^{f}}{{2}^{32 ( f - 1 )}} \leq \frac{N}{100}$$

Recall that a, d, and E[H] can be expressed in terms of k. So, the whole inequality can be expressed in terms of k and f. Similar to the single-digest scheme, N_{MAX} can be found by substitution.

The expected number of datagrams required to reconstruct the ingress address is now given by

$$E [ D ] = f \times k ( \frac{1}{f \times k} + \frac{1}{f \times k - 1} + … + 1 ) .$$

Table II provides the values of N_{MAX} and E[D] for selected combinations of f, a, k, and d.

TABLE II

| F | k | a | d | N_{MAX} | E[D] |
|---|---|---|---|---|---|
| 4 | 8 | 4 | 8 | 2911 | 130 |
| 4 | 4 | 8 | 5 | 2296 | 55 |
| 8 | 4 | 8 | 4 | 2479 | 130 |

The multiple digest modification is able to reconstruct more ingress addresses of simultaneous attackers than a single digest modification without increasing E[D]

Accommodating IP Fragmentation

According to recent studies fragmented traffic constitutes between about 0.25% and 0.5% of the total IP traffic. Though the amount of fragmented traffic is small, it does exist. The Deterministic Packet Marking (DPM) scheme, discussed so far herein, does not differentiate between fragmented and non-fragmented traffic. The ID Field, which is used for fragmentation, and RF of the IP header are completely replaced with one of f×k marks chosen at random in every packet. The ID field is used only for the reassembly of the fragmented traffic.

If fragmented traffic passes through the DPM interface, it will not be properly reassembled by the destination because the ID field would be changed. When DPM encounters fragments, it suspends the randomness in selecting the mark, and assigns the same mark to every fragment in the original series.

This results in the improved ratio of correctly reassembled fragmented traffic at the destination. Only about 0.3% of all fragmented traffic will be reassembled incorrectly due to DPM with this modification. The undesirable effect of this modification is the increased expected number of packets required for the reconstruction of the ingress address for the fragmented traffic, E[Pkt]. For the fragmented traffic, E[Pkt]=C×E[D], where C is the fragmentation coefficient and is equal to 3. E[Pkt]=E[D] for the not fragmented traffic. This increase becomes critical since that attacker may be able to utilize artificial fragmentation—generate packets which appear to be fragments for the purpose of obstructing the traceback. The effect of artificial fragmentation will be discussed further below.

Accommodating Fragmentation

Fragmented traffic constitutes; between 0.25% and 0.5% of the total IP traffic. Though the amount of fragmented traffic is small, it does exist. The DPM scheme discussed so far, did not differentiate between fragmented and non-fragmented traffic. The ID Field, which is used for fragmentation, and RF of the IP header are completely replaced with one of f×k marks chosen at random in every packet.

IP Fragmentation Background and Terminology

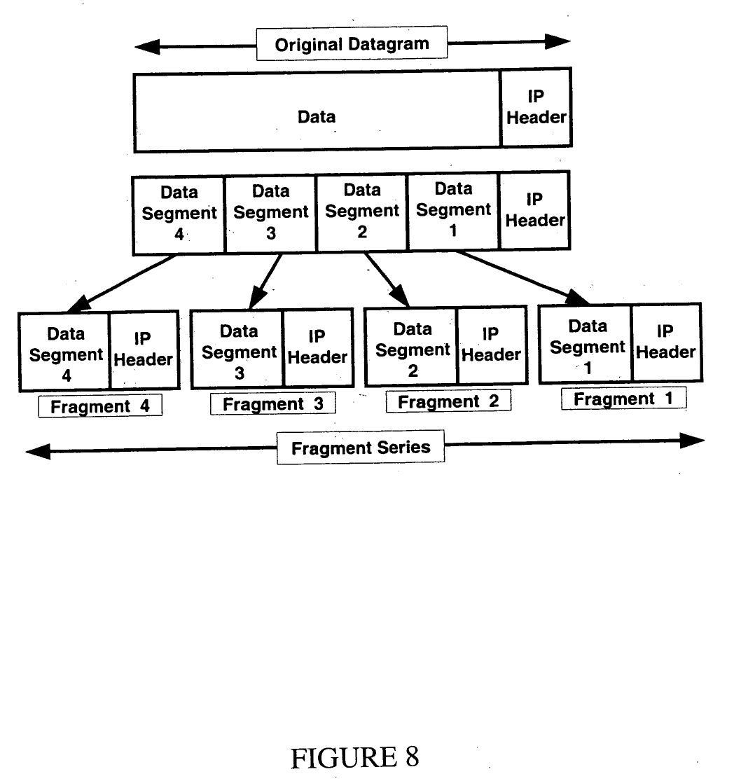

Fragmentation is a feature of IP to enable transport of packets across the networks with different Maximum Transfer Unit (MTU). Path MTU is the smallest MTU of all the links on a path from a source host to a destination host as described in Mogul and Deering, “Path MTU discovery”, Request for Comments (RFC) 1191, November 1990. When a packet enters a network, the MTU for which is smaller than the packet length, the packet has to undergo a process of fragmentation. FIG. 8 illustrates this process and introduces several important terms. “Original datagram” is an IP datagram that will be fragmented because its size exceeds the MTU of the next link. A “Packet Fragment”, or simply a “fragment”, refers to a packet containing a portion of the payload of an original datagram. While the datagram and packet are synonymous, the terms, “original datagram” and “packet fragment”, will be used for clarity. A “fragment series”, or simply a “series”, is an ordered collection of fragments that results from a single original datagram.

When fragmentation occurs, each fragment becomes a valid IP packet. All the fragments have their own IP header. Most of the fields of the IP header of the fragments are inherited from the original datagram IP header. The fields of interest are ID field, Flags, and Offset. ID field is copied from the original datagram to all the fragments. The SA, Destination Address (DA), Protocol (P), and ID, are used by the destination to distinguish the fragments of different series according to J. Postel, “Internet protocol” RFC 791, September 1981 and D. D. Clark, “IP datagram reassembly algorithms” RFC 815, July, 1982. The ID field of all the fragments, which resulted from a single datagram, must have their ID field in the IP header set to the same value for proper reassembly. More Fragments (MF) flag is set to ‘1’ in every fragment except the last one. This flag indicates that more fragments to follow. The last fragment has MF set to ‘0’ to indicate that it is the last fragment in the series. Finally, the offset field of the IP header is set to the position of the data in the fragment with respect to the beginning of data in the original datagram. The unit of offset is eight bytes.

For successful reassembly, the destination has to acquire all of the fragments of the original datagram. A tuple (SA, DA, P, ID) is used to determine if the fragments belong to the same original datagram, MF is used to indicate the number of fragments, and Offset is used to determine the correct order of reassembly. Notice that the fragments may come out of order but reassembly will still be successful because the destination would be able to determine that the fragment belongs to a given series, and its position relative to other fragments.

Since DPM uses the ID field for its purposes, the reassembly errors at the destination may occur. First the effects of the basic DPM on reassembly are examined and then the techniques to avoid the undesirable effects are introduced. The performance of the techniques is analyzed in terms of the probability of reassembly error.

Shortcomings of DPM related to Fragmentation

Fragmentation can happen upstream or downstream from the point of marking. These two situations have to be considered separately.

Upstream Fragmentation

Upstream fragmentation is known to the DPM-enabled interface. The DPM-enabled interface can identify a packet to be a fragment by examining its MF and Offset.

In the case of upstream fragmentation, a datagram is fragmented by a router or a host before it reaches the DPM-enabled interface. When a series of fragments of the original datagram reaches the DPM-enabled interface the ID and RF fields of all the fragments will be replaced with one of the f×k marks picked at random. This will cause fragments to have different ID fields when they arrive to the destination. Fragments with different ID fields will be considered to be parts of different datagrams. The reassembly will eventually timeout since the destination will never get all the fragments necessary for the reassembly of what it considers to be two separate series. The probability of all fragments in a series of two fragments having the same ID field after marking is (1/(fk)). For a series of three packets, (1/((fk)²)), etc. For f×k=16, the probability of a series consisting of two fragments being correctly reassembled is 6.25%, for a series of three fragments—0.4%. Clearly, the rate of reassembly errors caused by upstream fragmentation is unacceptable. The ability of DPM-enabled interface to recognize upstream fragmentation results in a different strategy for marking these packets as described previously herein.

Downstream Fragmentation

Downstream fragmentation is unknown to DPM. The DPM-enabled interface has no knowledge if the marked datagrams, are being fragmented anywhere along the path. Therefore, the datagrams, which will be fragmented after the marking cannot be treated differently from the traffic, which is not fragmented.

Luckily, fragmentation downstream from the DPM-enabled interface does not causes any problems for reassembly. The router, which is going to perform fragmentation, will simply insert the content of the ID field of the original datagram into every fragment. The value of RF will also be copied to every fragment as specified in F. Baker, “Requirements for IP version 4 routers”, RFC 1812, June, 1995. At the destination, reassembly will be successful since the ID field will be the same for every fragment in the series. The fact that the ID field was set by DPM, and replaced the original value set by the host is unknown to the destination, and is irrelevant for the purpose of reassembly.

Fragment-Persistent DPM

The modification to the DPM marking procedure which will eliminate most of the potential errors associated with upstream fragmentation is now considered. The fundamental modification will be discussed first, followed by gradual changes resulting in the final marking procedure.

Fundamentals of Handling Upstream Fragmentation with DPM

It is essential for proper reassembly that all of the fragments of the original datagram have the same ID field. The basic DPM marks packets randomly choosing among f×k marks. This randomness must be suspended when processing fragments. In order to accomplish this task, DPM has to keep track of the fragments which pass through. If a certain mark was inserted in the first fragment, that DPM-enabled interface encounters (which does not have to be the fragment with offset 0), then the same mark must be inserted into the rest of the fragments of this series. The information about which mark is used for which series has to be stored in a table, called FragTbl, at the DPM enabled interface and checked every time a new fragment arrives. To identify fragments belonging to the same original datagram, DPM should check if the tuple of the four fields utilized by the reassembly function (SA, DA, P, ID) is the same as any other it marked within the maximum reassembly timeout of 120 seconds.

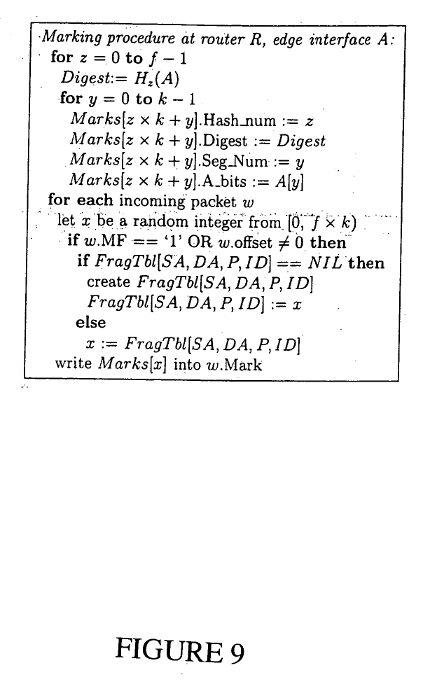

FIG. 9 illustrates the fundamental changes to the DPM marking procedure for fragmentation support. If the packet is not a fragment, there would be no changes in handling it. If, however, the packet is a fragment, then DPM determines if it is the first fragment in the series that it sees. If it is the first one, then the process is identical to the non-fragment case, but, in addition, DPM stores the result of the concatenated hash function number and segment number. This log₂(f−k)-bit pattern uniquely identifies every mark at this interface, and is arithmetically equal to the index of the Marks array used in the procedure. This would allow to set the mark of all the remaining fragments in this series to the same value as the first fragment. When the packet is identified as a fragment and DPM marking procedure was able to find the hash function number and the segment number assigned to its series, the corresponding mark is inserted. The reconstruction procedure at the victim will not change and will be identical to the reconstruction procedure of the basic DPM.

Dealing with Infinite Series

Assuming that an attacker can generate any packet, it is possible that he will utilize artificial fragmentation. That is sending packets with MF Flag set to ‘1’ or non-zero offset field when fragmentation is not necessary for the proper reason—the datagram exceeding the MTU of a given link. With artificial fragmentation, the attacker may generate infinitely many packets with the same SA, DA, P, and ID fields, that would look like fragments of one very long series to the DPM-enable interface or the destination. This is known as an infinite series. The invalid traffic would be noticed only by the destination at the reassembly function, but for (D)DoS attacks it would be enough that the invalid packets occupy the resources of the victim. In this situation, the victim will never recover the full ingress address since only a single mark would be available.

To remedy this situation, another simple modification in addition to fragment persistence must be introduced. The modification is based on the findings in Shannon et al., “Beyond folklore: observations in tragmental traffic”, IEEE/ACM Trans. Networking, vol. 10, No. 6, pp. 709-720, December 2002, where it was determined from the real traffic traces that the longest series on the Internet is 44 fragments. Deterministic Packet Marking should recognize the fact that if the number of fragments in the series exceeds 44, it is, in all likelihood, an attack, or a result of some errors. In either case, such traffic is not expected to be properly reassembled. So, after DPM has persistently marked 44 fragments of a single series with the same mark, any additional fragments from the same series will be marked randomly, as if it was not a fragment.

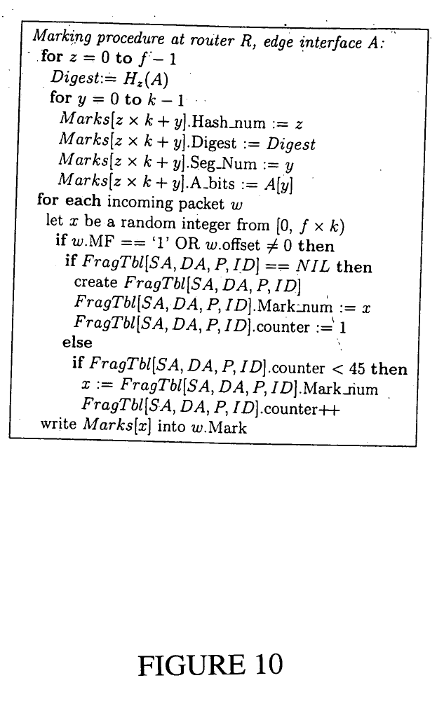

In order to implement this modification, the FragTbl, which DPM uses to account for fragments and where the segment value corresponding to (SA, DA, P, ID) is kept, should also keep a counter, which should be incremented every time a fragment with a given tuple is encountered. Once this counter exceeds 44, marking persistence should be suspended and randomness should be reinstated. FIG. 10 illustrates this concept with a pseudo code.

Practical Compromise

The modification described above will accommodate all of the valid fragmented traffic. However, artificial fragmentation may still be used by the attacker to generate bogus 44-fragment series directed to the victim. This will allow the attacker to increase the expected number of packets required to be marked by a DPM-enabled interface in order for the victim to be able to reconstruct its address, E[Pkt], by the factor of 44. It is possible to modify the procedure outlined above to significantly reduce this factor with the minimal trade-off.

According to C. Shannon, op. cit. about 99% of series are only two or three fragments long. This fact may be taken into consideration when resuming randomness. It follows then that if the randomness in selecting the mark is resumed after only three fragments have passed through the DPM-enabled interface, 99% of fragmented datagrams will be unaffected and will reassemble successfully at the destination. To the attacker, this will make sending series longer than three fragments to the victim totally pointless. For example sending a series of 45 fragments will result in three fragments marked with the same mark, and the remaining 42 fragments marked randomly. The marks will be picked at random 43 times. Assuming f×k=16, approximately 15 different marks will be sent to the victim, according to the classical occupancy problem discussed in Feller (op. cit.). The same number of packets may be sent to the victim if the attacker sends 15 series, three fragments each. All three fragments in every series will be marked with the same mark. Therefore, random mark will be picked only 15 times, resulting in approximately 10 different marks sent to the victim. Clearly, sending series of three fragments to the victim becomes the most sensible option for the attacker. While this approach will take care of all two and three fragment series, which account for 99% of all series, the remaining 1% of valid series, which contain more than three fragments will almost never get reassembled at the destination.

The compromise approach to the fragmentation problem is now presented. When the DPM-enabled interface encounters the first (not necessarily with offset 0) fragment in a series, it decides if the randomness will be suspended for three fragments or for 44 fragments in this series. The probability p, with which the randomness is suspended for 44 fragments, should be selected in such a way that there is no advantage to the attacker in sending series longer than three fragments.

Sending series of more than 44 fragments does not make any sense. It is certain that the marks selected at random will be inserted in the fragments after the 44th. However, the attacker may send series of exactly 44 fragments hoping that the number of packets sent to the victim would be greater than it were using three fragment series for the same number of marks. If the attacker generates 44 fragment series, the situation when only a single mark is inserted in all the fragments will occur with probability p. The alternative is the situation when only the first thee fragments will have the same mark, and the remaining 41 fragments will have randomly picked marks inserted. Thus, 42 randomly picked marks would be transferred to the victim in the fragments of this series. This situation will occur with probability (1−p).

It is desired to find the value of p such that the expected number of packets per randomly selected mark, C, is the same for both approaches. This would minimize the undesirable effect the modification has on longer valid series without creating any benefit to the attacker of using the longer artificial series. Denote D as the number of datagrams being sent. In case of sending series of three fragments, the expected number of times marks are randomly picked (different from the number of marks acquired by the victim) is D, and the number of packets sent to the victim is 3D. In case of sending 44 fragment series, the expected number of randomly chosen marks is D(42(1−p)+p), and the number of packets sent to the victim is 44D. The ratio of number of packets to the number of generated marks will be called a fragmentation coefficient C. For the two options of using artificial fragmentation, C must be the same.
((44D)/(D(42(1−p)+p)))=((3D)/D)
((44)/(42(1−p)+p))=3

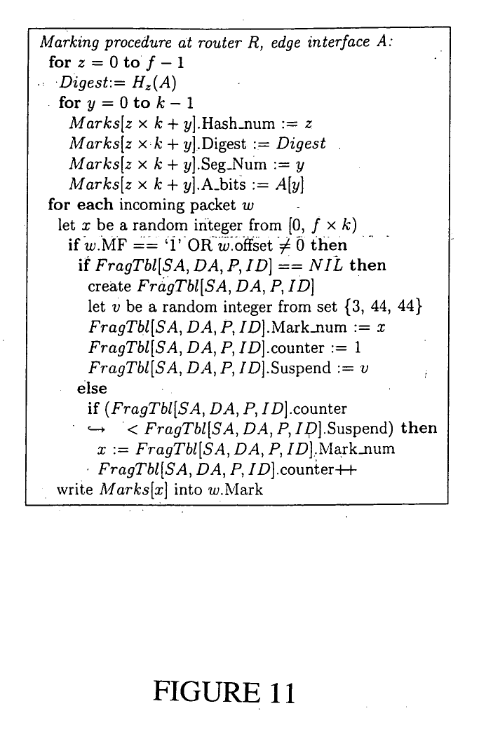

Solving for p results in the value of (⅔). It is important that the number of datagrams sent by the given host does not affect the value of p. This means that DPM can suspend randomness in mark selection for 44 fragments in two out of every three datagrams. Approximately 33.3% of the datagrams fragmented into more than three fragments upstream would fail to reassemble at the destination. The fragmented traffic is only 0.5% of the overall traffic. Therefore about 0.0017% of the overall traffic would be affected. The pseudo code of the encoding procedure reflecting the practical compromise is depicted in FIG. 11. Processing at the victim is not affected by any of these modificatinos.

Size of the FragTbl

The amount of memory required for the FragTbl is now analyzed. This is an important issue since this memory overhead will be incurred by the routers, and as was mentioned earlier the ISPs involvement for the scheme should be minimal. The amount of memory required for the FragTbl depends on the interface speed and will vary for different interfaces. In this section, the estimation of the size of FragTbl is presented.

The size of FragTbl is directly proportional to the rate of the DPM enabled interface, R. The interfaces with the higher rate are able to process more packets per second. As mentioned earlier, according to C. Shannon (op. cit.), approximately 0.5% of IP packets are fragmented. For every series, 12 Bytes (4-Byte SA, 4-Byte DA, 2-Byte ID, 1-Byte P, 4-bit fk value, and 1-bit required to store two values of threshold for the number of fragments to resume randomness) are allocated in the FragTbl and every entry should be held in the FragTbl for 120 seconds. Keeping the entry longer than 120 seconds is unpractical since the reassembly process at the destination of the fragments will timeout after 120 seconds according to R. Braden, “Requirements for Internet hosts—communications layers” RFC 1122 October, 1989. The average packet size of 1000 bits is conservatively considered as it was by A. Snoeren et al. “Single packet IP traceback IEEE/ACM Trans. Networking, 10, pp. 721-734, December, 2002. The recent traffic measurement studies suggest that the average packet size is, however is closer to 400 to 600 Bytes. It follows then that the size of the FragTbl in Bytes is given by:
((R bits/s s×1203×0.005×12 Bytes)/(1000 bits))=0.0072R M Bytes

Table III summarizes memory requirements of FragTbl for various commonly used interfaces. The interfaces, which are likely to be on the edges of even a large ISP, would not require more than 20 MBytes of Random Access Memory (RAM).

TABLE III
Interfaces, Rates and Estimated FragTbl Size

| | | |
|---|---|---|
| Interface | Rate | FragTbl Size |

| | | | | |
|---|---|---|---|---|
| OC-768 | 40 | Gb/s | 288 | MByte |
| OC-192, 10GigE | 10 | Gb/s | 72 | MByte |
| OC-48 | 2.5 | Gb/s | 18 | MByte |
| OC-24 | 1.25 | Gb/s | 9 | MByte |
| GigE | 1 | Gb/s | 7.2 | MByte |
| OC-12 | 622 | Mb/s | 4.5 | MByte |
| OC-3 | 155 | Mb/s | 1.12 | MByte |
| Fast Ethernet | 100 | Mb/s | 0.72 | MByte |
| OC-1 | 51.84 | Mb/s | 0.37 | MByte |
| DS3 | 44.736 | Mb/s | 0.33 | MByte |
| DS2 | 6.312 | Mb/s | | |
| DS1 | 1.544 | Mb/s | <64 | KByte |
| DS1C | 3.152 | Mb/s | | |
| DS0 | 64 | kb/s | | |

### Traceback

We now consider different types of possible attacks to which the victim may be subjected, and the traceback procedure designed to perform the traceback for various types of attacks.

Types of Cyber Attacks

In E. Carter, Cisco Secure Intrusion Detection Systems, 1^{st} ed. Indianapolis, Ind.: Cisco Press, October 2001, the attack signatures are divided into four classes: reconnaissance, informational, access, and denial of service. The first three classes can be combined into one in the context of the DPM traceback and will be called “intrusions”. The last class is the most challenging in terms of traceback and will be discussed separately.

Intrusions

The important characteristic of an intrusion is that the attacker is interested in receiving some information from the victim. The attacker is thus bound to using a stable IP address in order to receive the replies from the victim. Even if the attacker engages in an elaborate scheme when his/her address is spoofed, he/she is still capable of receiving the packets from the victim, and thus the traceback of such attack is still trivial.

Denial of Service Attacks

Denial-of-service attacks have become very popular recently. Currently, there is no complete comprehensive defense against these attacks. That is why the traceback of these attacks becomes even more important. The common goal of all denial-of-service attacks is to create a situation when the victim is unable to provide services to the customers. This is usually accomplished by exhausting physical or logical resources on the victim's servers and networks or the ISP uplink.

A required attribute of any DDoS attack is a collection of slaves. The slaves are the hosts on the Internet that the attacker compromises by using common vulnerabilities and bugs of the operating systems. When the attacker compromises a slave and gains full or partial control, the flood servers are installed in them. Since the attacker controls the slaves, it is possible to have the slaves generate any packet. Specifically, we are interested in the spoofed SA and artificial fragmentation. The DDoS attack may also involve reflectors, the uncompromised hosts with opened services (such as www), which are used to reflect the traffic from the slaves to the victim. The mechanism of reflection works as follows. The slaves forge the source address in the packet directed to the reflectors with the victim's IP address. As a result, the victim is being flooded by the replies, which were originated by the innocent servers. Note that the attacker has no control over the reflectors, and therefore only valid packets may be generated by a reflector. That is, the SA field will have the reflector's address, and the artificial fragmentation is not orchestrated by the reflectors.

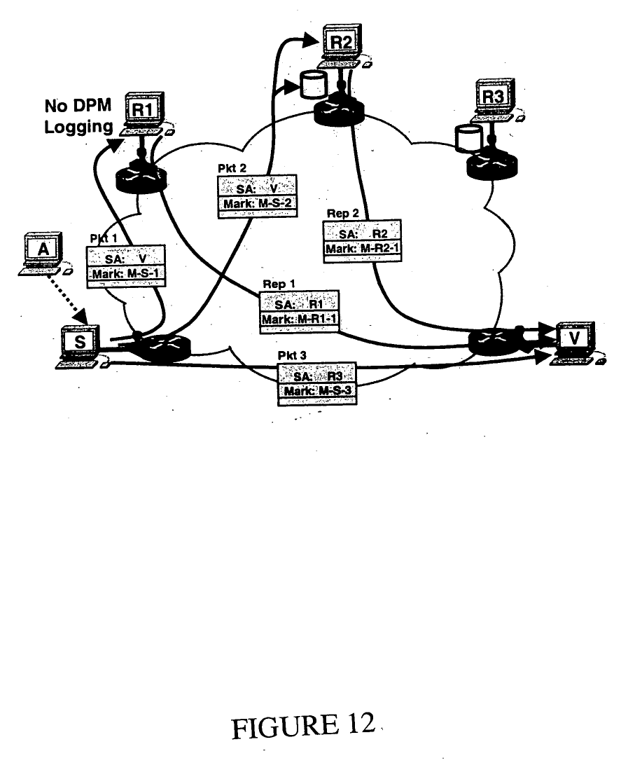

In the most general case of DDoS attack, called herein a “mixed DDoS attack”, the attacker may instruct the slaves to flood the victim directly and send the traffic to the reflectors, from which packets are reflected to the victim. In FIG. 12, slave S sends packets 1 and 2 to reflectors R1 and R2, respectively. The SA of these packets are spoofed with the address of the victim V. The generated replies 1 and 2 are then directed to V. Note that SA fields of the replies 1 and 2 are not spoofed and contain valid source addresses of R1 and R2. Also, S sends packet 3, with a spoofed SA for some random value R3, directly to V. The fact that S sends the packets to both V and R's constitutes a mixed DDoS. A major attack would involve hundreds or even thousands of slaves and may involve up to a million reflectors. It is worth mentioning that the mixed DDoS attacks have neither been reported nor described in literature, and at this time remain purely theoretical.

The popular DDoS attacks, which are currently exercised, are the special case of the mixed DDoS attack. One special case is a reflector-based DDoS attack, when slaves send packets only to reflectors, and the victim is flooded by the replies from the reflectors only. The other special case is a slave-based DDoS attack, when the slaves send packets only to the victim. The reflectors are not engaged in the slave-based attack. A special case of a slave-based DDoS attack is a DoS attack, when only a single slave participates in the attack.

Traceback Data Structures

The DPM traceback module has to be integrated with the Intrusion Detection System (IDS) of the victim. The IDS will have to notify the DPM Traceback module on which incoming packets constitute the attack.

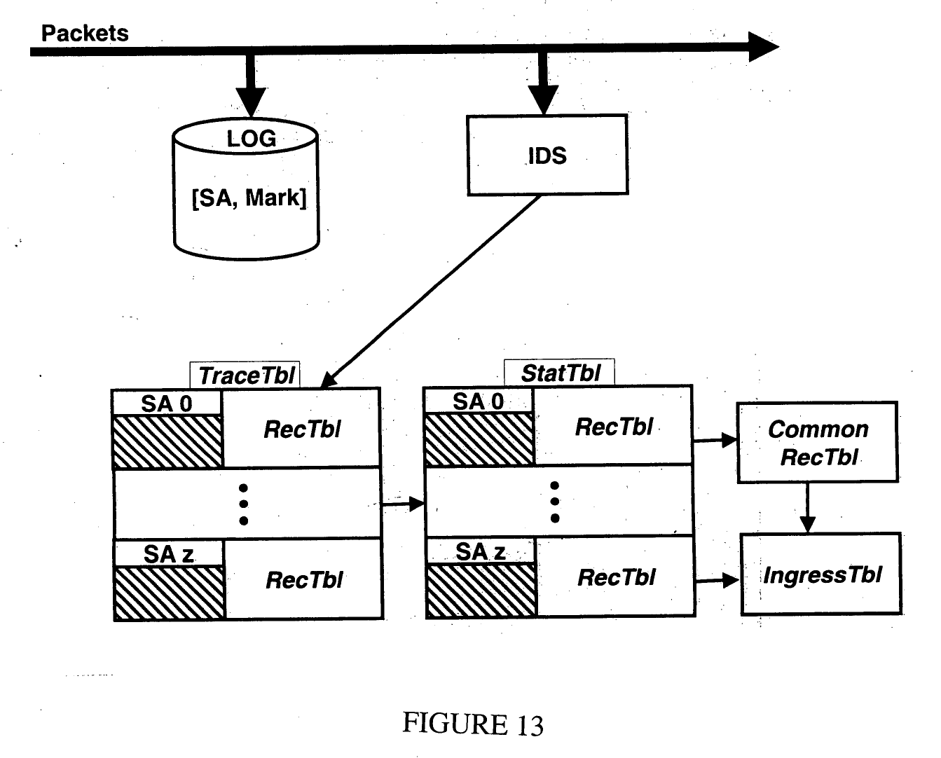

As a stream of packets enters the victim's network, the SA field and the mark of every packet must be logged, even if it is not considered an attack packet. The logging must be done in order to be able to collect the marks of slaves' interfaces from the reflectors in the reflector-based or mixed DDoS attacks, as will be discussed further herein and eventually reconstruct those ingress addresses, or to perform the traceback post-mortem. The IDS has to recognize the attack. The IDS can employ signature-based detection, anomaly-based detection as defined in P. Ferguson and D. Senie, Network Ingress Filtering: defeating denial of service attacks which employ {IP} source address spoofing, RFC 2827, May 2000; J. McHug, A. Christie and J, Allen, Defending Yourself: The role of Intrusion Detection Systems, IEEE Softw., Vol. 17, No. 5, pp. 42-51, Sept/October 2000, or a combination of both. The end result of the IDS function is a collection of packets, constituting the attack. For every attack, which IDS recognizes, DPM Traceback Procedure will create an instance of a TraceTbl The TraceTbl consists of a number of RecTbls. Each RecTbl is associated with a source address of one of the attack packets. In addition, there is a StatTbl, a data structure identical to TraceTbl, that is associated with the TraceTbl and is used solely for analysis of the marks. Finally, there is a common RecTbl, where final address reconstruction occurs. The ingress addresses may be recovered in StatTbl or the common RecTbl, and so they can be copied to IngressTbl from either data structure. FIG. 13 illustrates the data structures involved.

Tracing Slaves from Reflectors

Having identified potential reflectors in the reflector-based or the mixed DDoS attack, it may be possible to determine the ingress addresses of the slaves. By examining the DPM logs on the reflectors, if one were kept, it is possible to extract the marks from the packets which caused the reflectors to send the attack packets to the victim, and to use those marks in the tracing procedure on the victim. Recall that the attacker engages a reflector in the attack by sending a packet to it from a slave with the SA spoofed with the address of the victim. The reply to this packet, whatever it might be, is directed to the victim. Even though the attacker may change the SA of the packets, the DPM marks cannot be changed. Therefore, the marks of the packets to a reflector with the SA of the victim may be used to reconstruct the ingress address of the slave(s), which sent the packets to this reflector.

The protocol of obtaining the logs is known and the protocol may be exploited by the attackers. To mitigate this, the protocol may implement a new or existing security mechanism like, for example, IPSec. Here we emphasize the principles of being able to trace the slaves from the victim, not the actual implementation. A given reflector may have DPM logging enabled or disabled. When the victim makes a request to the reflector for the marks from the logs, the victim's address and the approximate time of packet arrival must be supplied. Three responses are possible: (1) Error (or no response), if the logging is not enabled on a given reflector; (2) Positive response, with the list of marks matching the specified parameters returned to the requesting victim; or (3) Negative response, if the logging on the reflector is enabled, but none of the logged entries matched the specified parameters.

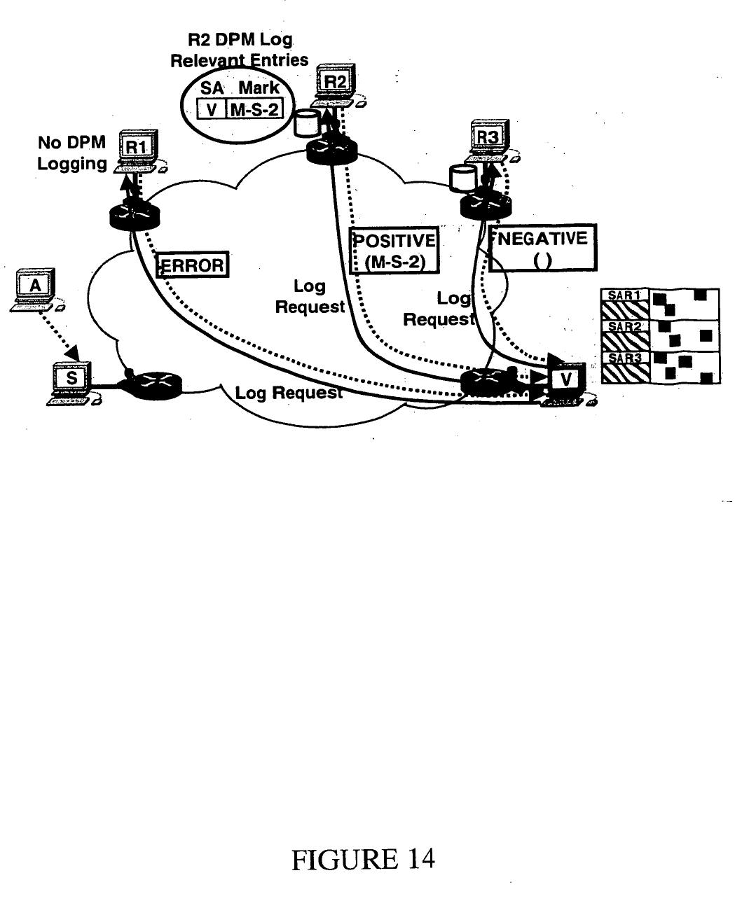

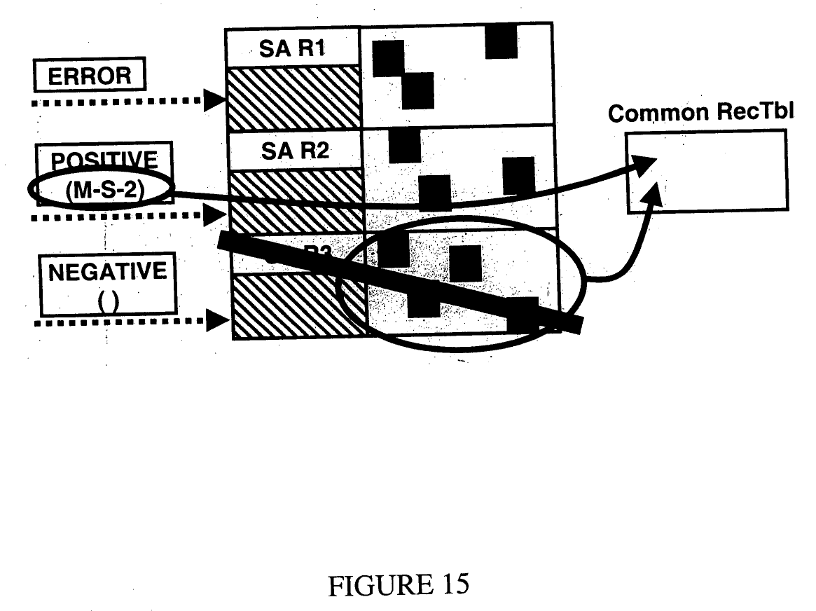

In FIG. 14, three reflectors are shown. R2 and R3 have DPM logging enabled and R1 does not. When V performs the traceback, the addresses of R1, R2, R3 will be available to V. At this point, V has no knowledge that the packet with SA of R3 was sent from a slave and SA was spoofed. V will send log requests to each of these addresses. FIG. 15 illustrates three possible responses to the log requests. When the log request is sent to R1, error (or no response at all—depending on implementation) is returned, since the logging was not enabled. R2 had logging enabled and had a record of packet with SA V. The marks (in this case only one) are sent in the response to V. R3 also has logging enabled; however, it did not receive any packets with SA V, and so the response is negative. Both positive and negative responses are useful to the victim as will be seen below.

Traceback Procedure

A single procedure must be able to handle all types of attacks discussed above. As the victim is being attacked, the attack packets will be identified. Every attack packet which arrives at the destination will have a mark. The appropriate bit of the RecTbl in the TraceTbl associated with the SA address of the attack packet will be set to ‘1’ as described in the foregoing.

Every T seconds or once the attack is over, the content of the TraceTbl is copied into StatTbl, which is used solely for the statistical analysis of the marks. The recording of the marks is not performed in StatTbl, although while the StatTbl is analyzed by the procedure, the incoming marks continue to be recorded in the TraceTbl. The StatTbl is used only to analyze the SAs and associated RecTbls.

First, the traceback procedure makes log requests to potential reflectors. SAs which have RecTbls associated with them would be used to address those reflectors. In case of a positive response from a reflector, the victim will obtain a list of marks from the slaves. It is certain that those marks are from the ingress interface of one or more slaves since they came in the packets that had the victim's SA, and so the marks received in the response are copied to the common RecTbl. It can be argued that the reflector could perform the traceback based on this marks by itself. However, the number of attack packets, which it would receive may not be enough for the IDS to recognize the attack, and even if the attack was recognized, the marks, which a single reflector would obtain, may not be enough for the traceback. In case of a negative response, the traceback procedure on the victim concludes that every mark in the RecTbl associated with that SA came from the ingress interface of one or more slaves. After the marks from this RecTbl are stored in the common RecTbl, this RecTbl is removed from the StatTbl and is not considered for further analysis. Only in case of no response, the procedure cannot make any conclusions and has to move on to the next SA in the StatTbl. These alternatives and the corresponding actions are depicted in FIG. 15.

We define a proper RecTbl as one where a single area of every part will have exactly k bits set to ‘1’. Moreover, none of the bits set to ‘1’ can be within the same segment. If any of those conditions are violated, then a given RecTbl is not proper. In other words, a proper RecTbl would have all marks necessary to reconstruct a single ingress address, and no other marks.

The procedure applies the address recovery process to every individual RecTbl. Any ingress addresses, which are reconstructed, are stored in the IngressTbl Moreover, if the RecTbl is proper, it is removed from the StatTbl.

At this point, the procedure may have identified some marks from the ingress addresses of the slaves by analyzing the responses from the reflectors and copying them to the common RecTbl, and may have removed some reflector marks from the StatTbl by deleting the proper RecTbls.

The number of potential marks from slaves' ingress addresses identified by the victim should not exceed \overline{M}_{SL}. \overline{M}_{SL} is the expected number of marks, which the victim would collect if attacked by N_{MAX} attackers simultaneously. \overline{M}_{SL} equals to the number of values a given segment in an area is expected to take, given by Eq. (2) multiplied by the number of segments in an area, multiplied by the number of areas in a part, and multiplied by the number of parts in a RecTbl.

$${\overline{M}}_{SL} = f \times {2}^{d} \times k [ {2}^{a} - {2}^{a} {( 1 - \frac{1}{{2}^{a}} )}^{\frac{N}{E [ H ]}} ] ,$$

where E[H] is given by Eq. (1). For f=4 and k=4, \overline{M}_{SL} is 32,038. This result was also supported by the simulation. Keeping the number of marks under \overline{M}_{SL} will ensure that the rate of false positives will not exceed 1%.

Depending on the attack profile, some marks remaining in the StatTbl at this point may be from the slaves' ingress addresses. A certain number of these remaining marks should be selected to be copied to the common RecTbl. The total number of already copied marks and the marks to be selected from the ones still remaining in StatTbl should not exceed \overline{M}_{SL}. We define the mark occurrence as the number of RecTbls in which that mark appears. In other words, if a given mark arrived multiple times in the packets with the same SA, only one occurrence would be counted. The remaining marks with the highest number of occurrence would be selected. Assuming that the marks are distributed uniformly in the interval of [0, 2¹⁷), the only reason for a certain marks to have a higher number of occurrence is that certain slaves have sent packets to the victim with different SAs. This results in the situation when the same marks appear in the RecTbls associated with different SAs, and thus its number of occurrence is increased. Therefore, marks with a higher number of occurrence are more likely to be from the slaves' ingress addresses. The marks with the highest number of occurrence are copied to the common RecTbl. The number of marks copied equals to \overline{M}_{SL}−n(com. :RecTbl), where n(com. :RecTbl) stands for the number of marks in the common RecTbl.

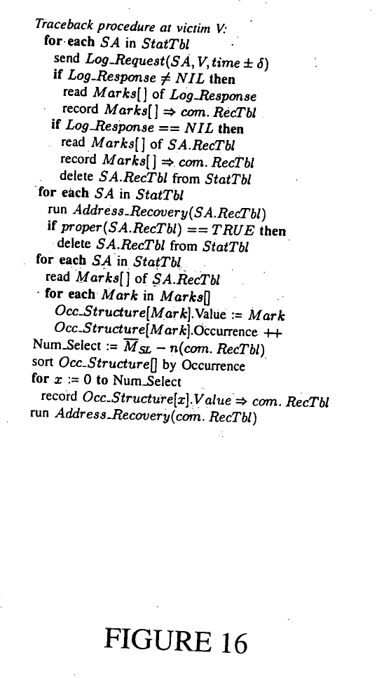

Finally, the address recovery process is applied on the common RecTbl and the ingress addresses are reconstructed. These can be the ingress addresses of slaves, reflectors which did not have a proper RecTbl associated with their SA, and false positives. A formal description of the procedure is presented in FIG. 16.

On Proper RecTbls and Hiding of the Marks

In regard to the concept of a proper RecTbl, recall that one of the steps of the procedure discussed above was to remove the proper RecTbl from the StatTbl. As part of the mixed DDoS, the attacker may attempt to send a packet from a slave with the SA of the reflector, which sent enough packets for the victim to collect a complete set of marks from its ingress interface. The attacker may try to create a situation where the mark in this packet would duplicate one of the marks sent by the reflector. Thus, once it is established that this RecTbl is proper, this mark will be deleted.

Intuitively, the chance of this situation occurring is very low. The attacker may find few slaves' ingress addresses which have one or even two segments the same as a targeted reflector. The probability that at least one of the digests is the same multiplied by the probability that this digest and that segment are picked in the only mark sent with this SA make this situation highly improbable.

On Deleting Marks from RecTbl

If the victim undergoes a mixed attack, the attacker could instruct the slaves to send packets with the SA of the reflectors, thus making sure that the marks will be recorded in a RecTbl associated with some or all of the reflectors. By having additional marks in those RecTbls, the attacker ensures that the marks from reflectors do not get deleted from the StatTbl. Why are the marks which were used in reconstruction of a valid ingress address not removed in the presence of other marks in the RecTbl? If the attacker came into possession of many slaves, it is possible to select reflectors in such a way that at least one out of f×k marks inserted by the DPM interface of the reflector is the same as one of the marks inserted by the DPM interface of the slave. The attacker may instruct the slave to send packets to the victim spoofing the SA to the SA of the reflector. If the slave does not send enough packets for the victim to collect all the marks in the RecTbl associated with the SA of the reflector so that the ingress address of that slave is reconstructed, then the ingress address of the slave will never be reconstructed if one of its marks is deleted. Therefore, the marks may be deleted from the StatTbl only if the traceback procedure is certain with high probability that only the marks from a single reflector's DPM interface are recorded in the given RecTbl; in other words, the RecTbl is proper.

Conditions for Traceability and Untraceable Attacks

Here we analyze the attacks which can and cannot be traced back with the procedure described above. All of the attacks will be analyzed from the point of view of the victim traceback procedure. Denote S as the number of slaves involved in the attack, L as a fraction of hosts on the Internet with enabled DPM logging, and C as the fragmentation coefficient.

We define marginally traceable attacks as the attacks during which the number of packets received by the victim, falls below the expected number of packets required for traceback. Yet, that number may be enough to collect all the marks necessary for traceback. We also define untraceable attacks as the attacks which can never be traced. The difference between the two is that while marginally untraceable can still be traced with the probability of success of less than 50%, the untraceable attacks cannot be possibly traced. For the marginally traceable attacks with multiple hosts involved, such as DDoS attacks, the victim may be able to trace back to some of the hosts involved in the attack.

Intrusions

The intrusion, as mentioned above, cannot have packets with the spoofed SA, and so theoretically a single packet identified by the IDS would be enough to perform the traceback. However, if the intruder engages in some elaborate scheme where his/her address is spoofed, but he/she is still capable of getting the desired information, DPM tracing procedure would have to be used. As mentioned before, artificial fragmentation will not provide any benefit to the attacker in terms of obstructing the traceback process, and therefore will not be utilized. The expected number of packets required for the traceback E[Pkt] is then E[D]. Therefore, the marginally traceable intrusion with the spoofed SA would be the one which contains up to E[D]−1 packets. The untraceable attack must consist of no more than f×k−1 packets.

DoS Attacks

The DoS attacks come from a single source, most likely with spoofed SAs in the attack packets, since the attacker is not interested in the replies from the victim. The number of marks required to be received would be f×k as described in the foregoing. The artificial fragmentation could be used by the attacker to be able to send more packets before the traceback becomes possible. In order for the victim to be able to trace the ingress addresses of the slaves participating in a DoS attack, C×E[D] packets must be received as mentioned in Section sec:Frag. Sending less datagrams than E[D] and f×k would produce marginally traceable and untraceable attacks, respectively. The respective number of packets would be C×(E[D]−1) and C×(f×k−1).

Slave-based DDoS Attacks

The slave-based DDoS attack can be considered as a number of DoS attacks executed simultaneously. The victim for all of those attacks is the same. The expected number of packets required to be able to trace any of the slaves' ingress addresses is C×E[D], as already discussed. Therefore, the marginally traceable slave-based DDoS attack may consist of up to S×(C×(E[D]−1) packets. An untraceable attack must consist of no more than S×(C×(f×k−1)) packets because in order for the whole attack to be untraceable, every slave must be untraceable.

Reflector-based DDoS Attacks

The reflector-based DDoS attack currently causes the most concern. The reflectors would be identified in the initial stage of the DPM tracing procedure. Identifying the reflectors is not a goal of the traceback. The reflectors are just the innocent servers with opened services used by the attacker to generate the traffic to the victim. The number of packets, which the collection of slaves may send in order to remain marginally traceable or untraceable, depends on the fraction of the hosts which perform DPM logging, and would be

$$\frac{S \times ( E [ D ] - 1 )}{L} and \frac{S \times ( f \times k - 1 )}{L} ,$$

respectively.
Mixed DDoS Attacks

We reemphasize the point that the attacks described in the following have not been reported or described in literature yet, and are theoretical at this point. Yet, it is essential that the traceback scheme is capable of handling the unknown as well as known attacks.

If L is sufficiently large, then using reflectors becomes detrimental to the attacker's cause to have his slaves untraceable. The slave-based attack will allow the attacker to send more packets while remaining marginally traceable or untraceable. If, on the other hand, very few hosts on the Internet implement DPM logging, and L is small, then the reflector-based attack will allow the attacker to attack the victim with more packets while keeping slaves marginally traceable or untraceable. Note that reflector-based DDoS and slave-based DDoS attacks are both special cases of mixed DDoS attacks. The number of packets that allow the attacker to wage marginally traceable attack is

$$max \{ \frac{S \times ( E [ D ] - 1 )}{L} , : S \times C \times ( E [ D ] - 1 ) \} ,$$

and the number of packets for the largest untraceable attack is

$$max \{ \frac{S \times ( f \times k - 1 )}{L} , : S \times C \times ( f \times k - 1 ) \} .$$

Two observations can be made. First, we observe that the number of reflectors is irrelevant for traceability of the attack. Notice that it does not appear in any of the expressions. Second, since C=3, about ⅓ of hosts on the Internet must have DPM logging enabled so that it becomes detrimental, in terms of the number of packets required for traceability, to the attacker to engage reflectors. Table III summarizes the findings of this section.

TABLE IV
Maximum Number of Packets for Marginally
Traceable And Untraceable Attacks

| Type of the Attack | Marginally Traceable | Untraceable |
|---|---|---|
| Intrusion | E[D] − 1 | f × k − 1 |
| DoS Attack | C × (E[D] − 1) | C × (f × k − 1) |
| Slave-based DDoS | S × C × (E[D] − 1) | S × C × (f × k − 1) |
| Reflector-based DDoS | $\frac{S \times ( E [ D ] - 1 )}{L}$ | $\frac{S \times ( f \times k - 1 )}{L}$ |
| Mixed DDoS | $max ( \frac{S \times ( E [ D ] - 1 )}{L} , S \times C \times ( E [ D ] - 1 ) )$ | $max ( \frac{S \times ( f \times k - 1 )}{L} , S \times C \times ( f \times k - 1 ) )$ |

Storage Requirements

16 KByte (2¹⁷ bits) of storage has to be allocated for every new SA involved in the attack. This number should be doubled since all RecTbls are copied to the StatTbl for analysis. If millions of reflectors and slaves are involved in the attack, the storage requirements may be large. This may be an issue if the storage facilities are not properly sized. Currently the storage is a commodity and there are TByte hard drives available commercially.

Simulation Results

Simulation results demonstrate DPM Traceback effectiveness. Several figures of merit are introduced to evaluate the performance of DPM which are affected by a number of independent variables. We have designed several illustrative attack profiles, which cover major attack types.

Description of the Simulation

The following parameters were the inputs to the simulation:

(1) Number of reflectors.

(2) Packets sent by each reflector. The reflectors generate packets in response to the packets from the slaves. We assume that for every packet from a slave to a reflector, the reflector will generate a single packet.

(3) Number of slaves. Even if the slaves do not attack the victim directly, such as in reflector-based DDoS attack, slaves generate packets to the reflectors. Slaves must participate in every type of attack.

(4) Packets per slave to the victim. Number of packets, sent by each slave directly to the victim. This does not include the number of packets, sent by each slave to reflectors.

(5) Use of artificial fragmentation by the slaves. Artificial fragmentation allows a slave to send several packets with the same mark to the victim. All of those packets must have the same SA. So, on one hand, artificial fragmentation decreases the number of marks received from the slave for a given number of packets, which is undesirable, but, on the other hand, it decreases the number of potential reflectors from which the logs must be requested, which is desirable.

(6) Percentage of packets from the slaves with random SA. Sending packets with the random SAs, not corresponding to the SAs of the reflectors has certain pros and cons from the attacker's point of view. Sending more packets from the slaves with random SA will result in the increased number of negative responses from the potential reflectors. While this makes traceback more time consuming, it would have better chances of identifying the slave marks, and then ingress addresses of the slaves. Sending packets with SAs of reflectors will decrease the number of logs polled.

(7) Percentage of hosts with DPM logging enabled L. This parameter indicates the number of hosts which will produce a response to a log request.

A configuration of the above parameters is called an attack profile. The first six parameters would be controlled directly by the attacker. The last one would not be controlled by the attacker, but is a major contributing factor in traceback effectiveness.

Some other data are directly related to the attack profile, and yet are not explicitly controlled by the attacker:

(8) Number of traceable slaves. Traffic from every slave will pass through a DPM-enabled interface. If enough packets from a given slave pass through it, then a complete set of marks will reach reflectors and/or victim. A slave, which sends enough packets to have its ingress interface traced, is called a traceable slave.

(9) Total number of packets sent to the victim. This signifies the severity of the attack. Usually, the impact of (D)DoS attack is directly related to the amount of traffic sent to the victim.

(10) Total number of marks from all slaves' ingress interfaces. This quantity is used by the simulation to establish how good the traceback is. In reality, the traceback procedure will never know how many marks were sent in the packets from the slaves.

According to the procedure described earlier herein, the first step is to send log requests. The following values are determined:

(a) Total Logs Requested.

(b) Number of Positive Responses.

(c) Number of Negative Responses.

(d) Number of errors (or no responses).

The respective percentages with respect to the total are also determined. After the victim has polled the logs, the following statistics are calculated:

(e) Correctly Identified Marks from Slaves' Ingress Interfaces. These are the identified marks, which were indeed inserted by the ingress DPM-enabled interfaces of the slaves. The percentage with respect to the total number of marks from all slaves is also calculated.

(f) Not Identified Marks from Slaves' Ingress Interfaces. These are marks which are not identified by requesting logs from reflectors.

(g) Incorrectly Identified Marks from Slaves' Ingress Interfaces. There should be no incorrectly identified marks at this stage of the procedure. However, when this statistic is recalculated later on, it indicates the number of marks which were not inserted by slaves' ingress interfaces.

The number of correctly and not identified marks should be equal to the number of marks from all slaves' ingress addresses. The incorrectly identified marks are a separate measure and refer to the amount of marks from reflectors' ingress addresses which were mistaken for the slaves' ingress addresses marks.

Finally, the marks with the highest occurrence are added to the common RecTbl as outlined in the discussion of tracing procedure. (The simulation does not check if the RecTbls in the StatTbl are proper. The output of the simulation, therefore, has a higher number of incorrectly identified marks from the slaves ingress interfaces as compared to what the actual procedure would have.) These steps are called additional processing at the victim. At this point, three final values are recalculated.

The simulation results for the multiple digest DPM configuration with f=4 and k=4 are described and summarized in Table V.

TABLE V
Table 6.2: Simulation Results for Selected Attack Profiles

| | | | Profile | | | |
|---|---|---|---|---|---|---|
| | | | 1 | 2 | 3 | 4 |
| Attack Characteristics | | # of Reflector | 0 | 10,000 | 10,000 | 10,000 |
| Controlled Directly | | Packets/Reflector | 0 | 200 | 200 | 200 |
| by the Attacker | | # of Slaves | 1,000 | 500 | 500 | 1,000 |
| | | Packets/Slave | 500 | 0 | 0 | 500 |
| | | Artificial Frag. | Yes | No | No | Yes |
| Attack Profile | {open oversize brace} | used by Slaves | | | | |
| | | Packets from Slaves | 100% | 100% | 100% | 50% |
| | | with random SA | | | | |
| | | Hosts with DPM | 75% | 100% | 0% | 50% |
| | | Logging Enabled | | | | |

| Attack Characteristics | Traceable Slaves | 1,000 | | 500 | | 500 | | 1,000 | |
|---|---|---|---|---|---|---|---|---|---|
| Indirectly | Packets sent to Victim | 500,000 | | 2,000,000 | | 2,000,000 | | 2,500,000 | |
| Controlled or not | | | | | | | | | |
| Controlled by the | Marks sent from Slaves' | 15,068 | | 7,768 | | 7,766 | | 15,060 | |
| Attacker | Ingress Interfaces | | | | | | | | |
| Outcome of | Total Logs requested | 166,666 | | 10,000 | | 10,000 | | 93,333 | |
| Requesting | | | | | | | | | |
| Reflector Logs | Positive responses | 0 | 0% | 10,000 | 100% | 0 | 0% | 5,000 | 5% |
| | Negative responses | 125,000 | 75% | 0 | 0% | 0 | 0% | 41,667 | 45% |
| | No responses | 41,667 | 25% | 0 | 0% | 10,000 | 100% | 46,667 | 50% |
| After Reflector | Correctly Identified | 11,492 | 76% | 7,768 | 100% | 0 | 0% | 9,635 | 64% |
| Log Requests | | | | | | | | | |
| Marks, from | Not Identified | 3,576 | 24% | 0 | 0% | 7,766 | 100% | 5,425 | 36% |
| Slaves' Ingress | Incorrectly Identified | 0 | 0% | 0 | 0% | 0 | 0% | 0 | 0% |
| Interfaces | | | | | | | | | |
| After Additional | Correctly Identified | 15,068 | 100% | 7,768 | 100% | 1,882 | 24% | 15,057 | 100% |
| Processing at | | | | | | | | | |
| Victim, Marks | Not Identified | 0 | 0% | 0 | 0% | 5,884 | 76% | 3 | 0% |
| from Slaves' | Incorrectly Identified | 0 | 0% | 24,270 | 76% | 30,156 | 94% | 16,981 | 53% |
| Ingress Interfaces | | | | | | | | | |

| | | | | |
|---|---|---|---|---|
| Comments | Slave-based | Reflector-based | Reflector-based | Mixed DDoS |
| | DDoS | DDoS | DDoS - no | |
| | | | logging | |

| | | Profile | | |
|---|---|---|---|---|
| | | 5 | 6 | 7 |
| Attack Characteristics | # of Reflector | 3,000 | 1,000 | 1,000 |

| | | | | | |
|---|---|---|---|---|---|
| Controlled Directly | | Packets/Reflector | 1,000 | 20 | 10 |
| by the Attacker | | # of Slaves | 2,250 | 1,000 | 1,500 |
| | | Packets/Slave | 5,000 | 80 | 20 |
| | | Artificial Frag. | Yes | Yes | Yes |
| Attack Profile | {open oversize brace} | used by Slaves | | | |
| | | Packets from Slaves | 100% | 50% | 0% |
| | | with random SA | | | |
| | | Hosts with DPM | 0% | 100% | 100% |
| | | Logging Enabled | | | |

| Attack Characteristics | Traceable Slaves | 2,250 | | 432 | | 0 | |
|---|---|---|---|---|---|---|---|
| Indirectly | Packets sent to Victim | 14,250,000 | | 100,000 | | 40,000 | |
| Controlled or not | | | | | | | |
| Controlled by the | Marks sent from Slaves' | 31,488 | | 14,392 | | 13,355 | |
| Attacker | Ingress Interfaces | | | | | | |
| Outcome of | Total Logs requested | 3,753,000 | | 14,333 | | 1,000 | |
| Requesting | | | | | | | |
| Reflector Logs | Positive responses | 0 | 0% | 1,000 | 7% | 1,000 | 100% |
| | Negative responses | 0 | 0% | 13,333 | 93% | 0 | 0% |
| | No responses | 3,753,000 | 100% | 0 | 0% | 0 | 0% |
| After Reflector | Correctly Identified | 0 | 0% | 12,763 | 89% | 8,127 | 61% |
| Log Requests | | | | | | | |
| Marks, from | Not Identified | 31,488 | 100% | 1,629 | 11% | 5,228 | 39% |
| Slaves' Ingress | Incorrectly Identified | 0 | 0% | 0 | 0% | 0 | 0% |
| Interfaces | | | | | | | |
| After Additional | Correctly Identified | 31,488 | 100% | 14,392 | 100% | 13,355 | 100% |
| Processing at | | | | | | | |
| Victim, Marks | Not Identified | 0 | 0% | 0 | 0% | 0 | 0% |
| from Slaves' | Incorrectly Identified | 550 | 2% | 9,887 | 41% | 6,638 | 33% |
| Ingress Interfaces | | | | | | | |

| | | | |
|---|---|---|---|
| Comments | Mixed DDoS - no | Marginally | Un-traceable |
| | logging | Traceable | Mixed DDoS |
| | | Mixed DDoS | |

Description of Profiles

Seven representative profiles are presented here.

Profile1

Profile 1 is a slave-based attack. 75% of hosts on the Internet support logging. Consequently, about 75% of the slave marks are identified by receiving negative responses to the log requests, which are sent to the spoofed addresses, since 100% of packets from slaves had a random SA. The total number of logs requested is 166,666, which is approximately ⅓ of the total number of packets. This can be explained by the fact that artificial fragmentation was used, and the same mark was sent three times in the packets with the same SA. As expected, 75% of requested hosts produce negative responses, and the rest return no responses.

The remaining marks are copied to the RecTbl by the victim when the traceback procedure gets to the stage of selecting marks with the highest occurrence. Since there were not enough marks in the StatTbl remaining to make the number of marks in common RecTbl to be \overline{M}_{SL}, all of the remaining marks were copied to the common RecTbl. 100% of slave marks were identified and copied to the common RecTbl by the end of the procedure; i.e. all 1,000 slaves' ingress addresses will be reconstructed.

Profile2

Profile 2 is a reflector based attack. Notice that slaves do not send packets directly to the victim. In this scenario, 100% of hosts on the Internet have DPM logging enabled. The full set of marks from slaves' ingress interfaces can be recovered by polling the logs of the reflectors. Further analysis by the victim identifies 24,270 more marks to be copied to the RecTbl. Our simulation does not implement checking for the proper RecTbl. This checking would likely result in fewer incorrectly identified marks. When the reconstruction process is applied to the common RecTbl, all of the slave ingress addresses will be reconstructed along with some reflector ingress addresses and some false positives. Most importantly, all of the marks from slaves' ingress addresses are identified.

Profile3

Profile 3 is identical to Profile 2 except that there are no hosts on the Internet with DPM logging enabled. The outcome of the traceback procedure is significant. As expected, none of the slave marks were identified by requesting the logs since there was no response to any of the request. When the victim attempted to select the marks with the highest number of occurrence, only some marks were identified correctly. The reason for these correctly identified marks from slaves' ingress interfaces is that reflectors have the same marks and those 1,882 had a higher number of occurrence. In other words, these were the reflector marks, which coincided with the slave marks. The outcome of the traceback procedure on Profile 3 attack is consistent with the conditions for traceability outlined in the dimension of conditions for traceability and untreaceable attacks, namely that reflector-based DDoS attacks cannot be traced if logging is not enabled on reflectors.

Profile4

Profile 4 is a mixed DDoS attack. 50% of the hosts on the Internet have DPM logging enabled, and 50% of all packets from slaves have random SAs. About 64% of all slave marks are identified by reflector log requests; the rest of them along with some other ones from the slaves are identified during the final processing by the victim.

Profile5

Profile 5 is similar to Profile 2 in that no hosts on the Internet implement DPM logging. However, the attack of this profile is a mixed DDoS attack, and the slaves send traffic to the victim as well. This allows the victim to identify all of the marks from the slaves after the request of reflectors' logs produced no results. Also notice that in this case, since slaves send a lot of packets to the victim, and all of them have random SA, more than 3.75M requests to the reflectors would have to be made.

Profile6

Profile 6 is a marginally traceable attack. Recall from the foregoing that in order to be marginally traceable a slave has to send between f×k and E[D] datagrams during the attack. The slaves in this attack send 27 datagrams (3 fragments each datagram) each since artificial fragmentation is used for the traffic from the slaves to the victim. Most of the marks are identified by requesting the logs. The rest are identified during the final victim processing. Even though all of the marks are identified and copied to the common RecTbl, only 432 out of 1,000 slaves' ingress addresses will be reconstructed, since only 432 sent enough packets to make a complete set of marks available.

Profile7

Profile 7 is an untraceable mixed DDoS attack. Recall that in order to be untraceable, a slave has to send less than f×k datagrams. Every slave sends 12 datagrams in total. Even though all of the marks from the slaves are identified and copied to the common RecTbl by the end of the traceback procedure, none of the slaves' ingress addresses will be reconstructed since none of them sent enough packets to have a complete set of marks for any of the ingress interfaces available to the victim and reflectors.

While the present invention has been described in terms of specific embodiments thereof, it will be understood in view of the present disclosure, that numerous variations upon the invention are now enabled to those skilled in the art, which variations yet reside within the scope of the present teaching. Accordingly, the invention is to be broadly construed, and limited only by the scope and spirit of the claims now appended hereto.

1. A method for collecting one or more bits of one or more network addresses comprising:
receiving one or more data packets with information comprising one or more bits of one or more network addresses written into the packets;
sending one or more requests for the one or more bits of the one or more network addresses; and
receiving one or more reply with the requested one or more bits of the one or more network addresses.

2. The method of claim, 1 further comprising storing one or more bits of the one or more network address in a data structure.

3. The method of claim 2, further comprising reconstructing one or more network addresses by processing the data structure.

4. A system for collecting one or more bits of one or more network addresses comprising:
an output interface for sending one or more requests for the one or more bits of the one or more network addresses; and
an input interface for:
(1) receiving one or more data packets with information comprising one or more bits of one or more network addresses written into the packets; and
(2) receiving one or more reply with the requested one or more bits of the one or more network addresses; and
a processor for:
(1) storing the received one or more bits in a data structure; and
(2) reconstructing one or more network addresses.

5. A method for IP traceback by a victim of an anonymous attack on the internet, for identifying the origin of attack packets; comprising:
requesting logs from potential reflectors utilizing SAs which have RecTbls associated with them to address those reflectors, whereby in case of a positive response from a reflector, the victim will obtain a list of marks from the associated slaves;
copying the marks received in the response to the common RecTbl;
concluding in the case of a negative response that every mark in the RecTbl associated with that SA came from the ingress interface of one or more said slaves;
applying the address recovery process to every individual RecTbl, storing any ingress addresses which are reconstructed are in the IngressTbl, and removing the RecTbl, if proper, from the StatTbl; wherein a proper RecTbl is one having all marks necessary to reconstruct a single ingress address, and no other marks; and
applying the address recovery process on the common RecTbl, and reconstructing the ingress addresses.

6. A method in accordance with claim 5, wherein said attack is a DoS attack.

7. A method in accordance with claim 6, wherein said DoS attack utilizes slaves.

8. A method in accordance with claim 6, wherein said attack is a DoS attack is based on reflectors.

9. A method in accordance with claim 5, wherein said attack is an intrusion.

10. A method in accordance with claim 5, wherein the pseudo code for the DPM algorithm is given by:
Traceback procedure at victim V:
for each SA in StatTbl
send Log_Request(SA, V, time±δ)
if Log_Response≠NIL then
read Marks[ ] of Log_Response
record Marks[ ] [symbol] com. RecTbl
if Log_Response==NIL then
read Marks[ ] of SA.RecTbl
record Marks[ ] [symbol] com. RecTbl
delete SA.RecTbl from StatTbl
for each SA in StatTbl
run Address_Recovery(SA.RecTbl)
if proper(SA.RecTbl)==TRUE then
delete SA.RecTbl from StatTbl
for each SA in StatTbl
read Marks[ ] of SA.RecTbi
for each Mark in Marks[ ]
Occ_Structure[Mark].Value :=Mark
Occ_Structure[Mark].Occurrence++
Num_Select :=\overline{M}_{SL}−n(com. RecTbl)
sort Occ_Structure[ ] by Occurrence
for χ :=0 to Num_Select
record Occ_Structure[χ].Value [symbol] com. RecTbl
run Address_Recovery(com. RecTbl)
